(19) United States
(12) Patent Application Publication
(10) Pub. No.: US 2014/0113228 A1
(43) Pub. Date: Apr. 24, 2014

(54) TONER, TWO-COMPONENT DEVELOPER, AND IMAGE FORMING METHOD

(71) Applicants: Yoshiaki Shiotari, Mishima-shi (JP); Kosuke Fukudome, Tokyo (JP); Nozomu Komatsu, Toride-shi (JP); Kunihiko Nakamura, Gotemba-shi (JP); Kentaro Kamae, Kashiwa-shi (JP); Hiroyuki Fujikawa, Yokohama-shi (JP); Koh Ishigami, Abiko-shi (JP); Takayuki Itakura, Mishima-shi (JP)

(72) Inventors: Yoshiaki Shiotari, Mishima-shi (JP); Kosuke Fukudome, Tokyo (JP); Nozomu Komatsu, Toride-shi (JP); Kunihiko Nakamura, Gotemba-shi (JP); Kentaro Kamae, Kashiwa-shi (JP); Hiroyuki Fujikawa, Yokohama-shi (JP); Koh Ishigami, Abiko-shi (JP); Takayuki Itakura, Mishima-shi (JP)

(73) Assignee: CANON KABUSHIKI KAISHA, Tokyo (JP)

(21) Appl. No.: 14/124,985

(22) PCT Filed: May 30, 2012
(86) PCT No.: PCT/JP2012/064496

§ 371 Date: Dec. 9, 2013

(30) Foreign Application Priority Data
Jun. 10, 2011 (JP) 2011-130263

(51) Int. Cl. G03G 9/08; G03G 13/095

(52) U.S. Cl. CPC G03G 9/0819; G03G 13/095
USPC 430/108.8; 430/124.1

(57) ABSTRACT

A toner has a weight-average particle diameter (D4) of 3.0 μm or more and 8.0 μm or less, wherein the average circularity analyzed by dividing particles of the toner having an equivalent circle diameter of 1.98 μm or more and less than 200.00 μm into 800 in a range of a circularity of 0.200 or more and 1.000 or less is 0.960 or more and 0.985 or less, the proportion of particles A having a circularity of 0.990 or more and 1.000 or less is 25.0% or less on a basis of the number of particles, and the ratio of particles B having an equivalent circle diameter of 0.50 μm or more and less than 1.98 μm to the total particles having an equivalent circle diameter of 0.50 μm or more and less than 200.00 μm is 10.0% or less on a basis of the number of particles.

### TECHNICAL FIELD

The present invention relates to a toner used for an electrophotographic system, an electrostatic recording system, an electrostatic printing system, or a toner-jet system, a two-component developer containing the toner, and an image forming method using the toner.

### BACKGROUND ART

In order to realize good image properties in electrophotographic apparatuses for a long period of time, toners are required to have both good transferability and good cleanability. For this purpose, controlling a distribution state of toner particles having a particular shape has been hitherto conducted.

In PTL 1, both good transferability and good cleanability are intended to be realized by specifying the average circularity and the circularity distribution of toner particles having an equivalent circle diameter of 3.00 μm or more among toner particles.

In PTL 2, the transfer efficiency is improved and a higher image quality is realized by controlling the percentage of the number of toner particles having a circularity of 0.950 or less among toner particles having a particle diameter of 2 μm or more and 5 μm or less to be 40% or less to optimize the shapes of toner particles having small particle diameters.

### CITATION LIST

### Patent Literature

PTL 1 Japanese Patent Laid-Open No. 2005-107517
PTL 2 Japanese Patent Laid-Open No. 2008-076574

### SUMMARY OF INVENTION

### Technical Problem

The toner described in PTL 1 has a small average circularity, and transferability and a developing property of the toner may be further improved.

Furthermore, according to the results of examinations about the toner disclosed in PTL 2 conducted by the inventors of the present invention, in the case where the toner contains a large amount of toner particles having a particle diameter of less than 2 μm and an image is printed on 10,000 sheets or more under the condition of a printed image ratio of 40%, toner-spent occurs on a magnetic carrier, and thus the image density may decrease.

The present invention provides a toner which has a good transfer efficiency and good cleanability, in which a change in the image density is suppressed when a large number of sheets are copied or printed and thus which has good stress resistance. The present invention further provides a two-component developer and image forming method using the toner.

### Solution to Problem

The present invention provides a toner including toner particles each of which contains a binder resin and a wax; and inorganic fine particles, wherein (i) the toner has a weight-average particle diameter (D4) of 3.0 μm or more and 8.0 μm or less, (ii) in a measurement using a flow particle image measuring apparatus with an image processing resolution of 512×512 pixels, the toner satisfies conditions (a) regarding particles having an equivalent circle diameter of 1.98 μm or more and less than 200.00 μm, the average circularity of the toner is 0.960 or more and 0.985 or less, and the proportion of particles having a circularity of 0.990 or more and 1.000 or less is 25.0% or less on a basis of the number of particles, and (b) the ratio of particles having an equivalent circle diameter of 0.50 μm or more and less than 1.98 μm to particles having an equivalent circle diameter of 0.50 μm or more and less than 200.00 μm is 10.0% or less on a basis of the number of particles, and (iii) the relationship of formula (1) is satisfied:

1.20≦P1/P2≦2.00 Formula (1)

where P1=Pa/Pb and P2=Pc/Pd, Pa and Pb respectively represent a maximum absorption peak intensity in the range of 2,843 cm⁻¹ or more and 2,853 cm⁻¹ or less and a maximum absorption peak intensity in the range of 1,713 cm⁻¹ or more and 1,723 cm⁻¹ or less in a Fourier transform infrared (FT-IR) spectrum of the toner measured by an attenuated total reflection (ATR) method using germanium (Ge) as an ATR crystal at an angle of incidence of infrared light of 45°, and Pc and Pd respectively represent a maximum absorption peak intensity in the range of 2,843 cm⁻¹ or more and 2,853 cm⁻¹ or less and a maximum absorption peak intensity in the range of 1,713 cm⁻¹ or more and 1,723 cm⁻¹ or less in an FT-IR spectrum of the toner measured by an ATR method using KRS5 as an ATR crystal at an angle of incidence of infrared light of 45°.

The present invention provides a two-component developer and image forming method using the toner.

### Advantageous Effects of Invention

The present invention can provide a toner that has good durability and that realizes both a good transfer efficiency and good cleanability.

### BRIEF DESCRIPTION OF DRAWINGS

FIG. 1 is a diagram illustrating a flow of a heat treatment apparatus.

FIGS. 2A to 2C are views illustrating a heat treatment apparatus.

FIG. 3 is a partial cross-sectional perspective view illustrating an example of a hot-air supply unit 2 and an air flow-adjusting portion 2A.

FIG. 4 is a partial cross-sectional perspective view illustrating an example of a first cold-air supply unit 3 and an air flow-adjusting portion 3A.

FIG. 5 is a view illustrating a heat treatment apparatus that has been hitherto used.

### DESCRIPTION OF EMBODIMENTS

A toner according to the present invention has a weight-average particle diameter (D4) of 3.0 μm or more and 8.0 μm or less, and the toner satisfies the following condition (a) in a measurement using a flow particle image measuring apparatus with an image processing resolution of 512×512 pixels (0.37 μm×0.37 μm per pixel): (a) Regarding particles having an equivalent circle diameter of 1.98 μm or more and less than 200.00 μm, the average circularity is 0.960 or more and 0.985 or less, and the proportion of particles having a circularity of 0.990 or more and 1.000 or less is 25.0% or less on a basis of the number of particles. More preferably, the average circularity of the toner is 0.960 or more and 0.975 or less and the proportion of particles having a circularity of 0.990 or more and 1.000 or less is 20.0% or less on a basis of the number of particles.

A toner particle having a shape similar to a sphere has a small contact area with an image bearing member (photosensitive member) and thus has a low adhesive force to the photosensitive member, as compared with a toner particle having an irregular shape. Furthermore, regarding an electric field formed in a transfer step, as the shape of the toner particle approaches that of a sphere, the electric field is applied more uniformly, and the toner particle is transferred to a transfer material more easily. For this reason, in general, as the shape of the toner particle approaches that of a sphere, the transfer efficiency becomes higher. On the other hand, as the shape of the toner particle approaches that of a sphere, the contact area between the toner and a cleaning blade becomes smaller. Consequently, it is difficult to scrape off a transfer residual toner on the image bearing member with the cleaning blade, and the cleanability decreases. Thus, there is a trade-off between transferability and cleanability to a certain degree, and it is difficult to realize both good transferability and good cleanability. In particular, the proportion of particles having a circularity of 0.990 or more affects the decrease in the cleanability. However, there is a positive correlation between the proportion of particles having a circularity of 0.990 or more and the average circularity. If the proportion of particles having a circularity of 0.990 or more is decreased, the average circularity is also decreased, thereby decreasing transferability. Accordingly, in order to realize both good transferability and good cleanability, it is necessary to control the average circularity and the circularity distribution of the toner within an appropriate range.

As a result of intensive studies conducted by the inventors of the present invention, it was found that both a high transfer efficiency and good cleanability can be realized when the average circularity is 0.960 or more and 0.985 or less and the proportion of particles having a circularity of 0.990 or more and 1.000 or less is 25.0% or less on a basis of the number of particles.

The reason for this is as follows. In general, the larger the proportion of particles having a circularity of 0.990 or more and 1.000 or less in a toner, the wider the circularity distribution of the toner. In the case where a toner having a wide circularity distribution is used, a large number of toner particles having a shape similar to a sphere are present in a transfer residual toner, as compared with the case where a toner having the same average circularity and a narrower circularity distribution is used. The toner particles having a shape similar to a sphere easily pass through a gap of a cleaning blade, and thus contaminate a charging roller. Consequently, image defects due to uneven charging on the image bearing member tend to occur.

On the other hand, in the case where the above-described toner having a narrow circularity distribution is used, the amount of transfer residual toner particle having a shape similar to a sphere is smaller than that in the case where a toner having a wide circularity distribution is used. As a result, in the case where the toner having a narrow circularity distribution is used, most of the transfer residual toner particles are scraped off with the blade and thus good cleanability can be realized. In the case where the proportion of particles having a circularity of 0.990 or more and 1.000 or less exceeds 25.0% on a basis of the number of particles, the cleanability decreases because the amount of toner particles having a shape similar to a sphere is large.

In the case where the average circularity is less than 0.960, a large amount of toner particles having an irregular shape are present. Accordingly, a large amount of transfer residual toner remains on an image bearing member and the transfer efficiency is not sufficient. In addition, in outputting an image, the amount of toner necessary for obtaining a sufficient image density is increased, and this is disadvantageous in terms of running cost. In the case where the average circularity exceeds 0.985, the transfer efficiency is satisfactory. However, since the amount of toner particles having a shape similar to a sphere is large, the transfer residual toner easily passes through the gap between the image bearing member and the cleaning blade. Thus, the transfer residual toner remains on the image bearing member. As a result, the transfer residual toner contaminates a charging roller, which may result in charging failure of the image bearing member. In addition, image defects may be caused during image forming by uneven charging on the image bearing member due to the transfer residual toner on the image bearing member. This phenomenon significantly occurs particularly in the case where the outermost surface of the image bearing member cannot be scraped with the cleaning blade.

According to the toner of the present invention, the following condition (b) is satisfied in a measurement using a flow particle image measuring apparatus with an image processing resolution of 512×512 pixels (0.37 μm×0.37 μm per pixel): (b) The ratio of particles having an equivalent circle diameter of 0.50 μm or more and less than 1.98 μm to particles having an equivalent circle diameter of 0.50 μm or more and less than 200.00 μm is 10.0% or less on a basis of the number of particles. In condition (b), the proportion of particles having an equivalent circle diameter of 0.50 μm or more and less than 1.98 μm is more preferably 7.0% or less on a basis of the number of particles.

In the case where the proportion of particles having an equivalent circle diameter of 0.50 μm or more and less than 1.98 μm is 10.0% or less on a basis of the number of particles, toner-spent on the surface of a magnetic carrier can be suppressed when the toner of the present invention is used as a two-component developer. Accordingly, it is possible to suppress a decrease in a triboelectric charge-imparting property of the magnetic carrier. Thus, the extension of the life of the developer can be realized particularly in the long-term endurance (the formation of an image on a large number of sheets) at a high coverage (at a printed image ratio of 40% or more) where a large amount of toner is consumed.

On the other hand, when the proportion of particles having an equivalent circle diameter of 0.50 μm or more and less than 1.98 μm exceeds 10.0% on a basis of the number of particles, in the long-term endurance at a high coverage (printed image ratio: 40% or more), the surface of the magnetic carrier is spent by the particles having an equivalent circle diameter of 0.50 μm or more and less than 1.98 μm by a stress in a developing device. As a result, the triboelectric charge-imparting property of the magnetic carrier decreases, thereby decreasing the amount of triboelectric charge of the toner. Consequently, a decrease in the image density, fogging in a non-image area, and scattering of the toner in the developing device may occur.

Hitherto, it has been very difficult to obtain a toner which has an average circularity of 0.960 or more and 0.985 or less and in which the ratio of toner particles having a circularity of 0.990 or more is suppressed to 25.0% or less on a basis of the number of particles, and the ratio of toner particles having an equivalent circle diameter of 0.50 μm or more and less than 1.98 μm is suppressed to 10.0% or less on a basis of the number of particles.

For example, in the case where toner particles are prepared by an emulsion aggregation method, it is possible to obtain a toner which has an average circularity of 0.960 or more and 0.985 or less and in which the proportion of particles having a circularity of 0.990 or more is 25.0% or less on a basis of the number of particles. However, in the case where toner particles are prepared by the emulsion aggregation method, the ratio of toner particles having an equivalent circle diameter of 0.50 μm or more and less than 1.98 μm exceeds 10.0% on a basis of the number of particles. This is due to residual emulsified particles generated in a process of producing the toner. On the other hand, regarding a toner containing toner particles obtained by a suspension polymerization method, the average circularity is very high and the ratio of toner particles having a circularity of 0.990 or more also exceeds 25.0% on a basis of the number of particles.

Regarding a toner containing toner particles obtained by a known pulverization method, the average circularity is less than 0.960. An example of a method for increasing the average circularity of the toner containing toner particles obtained by the pulverization method is the spheroidization of the toner particles with a heat treatment apparatus. However, in the case where a common heat treatment apparatus is used, although the resulting toner has an average circularity of 0.960 or more and 0.985 or less, the proportion of particles having a circularity of 0.990 or more exceeds 25% on a basis of the number of particles. The reason for this will be described in detail below.

Furthermore, the toner of the present invention satisfies the relationship of formula (1):

1.20≦P1/P2≦2.00 Formula (1)

where P1=Pa/Pb and P2=Pc/Pd, Pa and Pb respectively represent a maximum absorption peak intensity in the range of 2,843 cm⁻¹ or more and 2,853 cm⁻¹ or less and a maximum absorption peak intensity in the range of 1,713 cm⁻¹ or more and 1,723 cm⁻¹ or less in an FT-IR spectrum of the toner measured by an ATR method using Ge as an ATR crystal at an angle of incidence of infrared light of 45°, and Pc and Pd respectively represent a maximum absorption peak intensity in the range of 2,843 cm⁻¹ or more and 2,853 cm⁻¹ or less and a maximum absorption peak intensity in the range of 1,713 cm⁻¹ or more and 1,723 cm⁻¹ or less in an FT-IR spectrum of the toner measured by an ATR method using KRS5 as an ATR crystal at an angle of incidence of infrared light of 45°.

P1 is an index related to the abundance ratio of the wax to the binder resin at a position about 0.3 μm away from a toner surface in a depth direction of the toner, the direction extending from the toner surface to a toner center portion, and P2 is an index related to the abundance ratio of the wax to the binder resin at a position about 1.0 μm away from the toner surface.

In the present invention, the index P1 related to the abundance ratio of the wax to the binder resin at a position about 0.3 μm away from a toner surface is controlled to be larger than the index P2 related to the abundance ratio of the wax to the binder resin at a position about 1.0 μm away from the toner surface, thus controlling an index ratio [P1/P2] related to the abundance ratio (i.e., the degree of uneven distribution of the wax in a depth direction of the toner, the direction extending from the toner surface to a toner center portion). It is believed that durability of the toner can be improved by controlling the ratio [P1/P2] in the above range, as described below.

In order to satisfactorily exude a wax from a toner, the wax needs to be present on the surface of the toner to a certain degree. The abundance ratio of the wax in the range from the toner surface to a depth of about 0.3 μm contributes to the exudation of the wax from the toner. However, when the abundance ratio of the wax on the toner surface increases, the toner surface is softened and inorganic fine particles tend to become embedded therein. Consequently, durability of the toner is decreased.

On the other hand, not only the softness on a toner surface layer but also the softness of a lower layer located thereunder relates to the embedding of inorganic fine particles. For example, even if the proportion of wax on the top surface layer of the toner is high, the inorganic fine particles are not embedded to the extent that the function thereof is lost as long as the lower layer located under the top surface layer is formed of a hard resin layer. The range from the toner surface layer to a depth of about 1.0 μm relates to this embedding of inorganic fine particles.

By controlling the ratio [P1/P2] in the above range, the abundance ratio of the wax in the range from the toner surface to a position of about 0.3 μm becomes higher than the abundance ratio of the wax in the range from the toner surface to a position of about 1.0 μm in a depth direction of the toner, the direction extending from the toner surface to a toner center portion. Specifically, the resin becomes harder from the toner surface layer having a high wax content toward the toner center portion. As a result, excessive embedding of inorganic fine particles is suppressed, and durability of the toner can be improved.

The ratio [P1/P2] of the toner is preferably 1.25 or more and 1.90 or less, and more preferably 1.30 or more and 1.80 or less.

In order to control the ratio [P1/P2] of the toner in the above range, P1 and P2 are independently controlled by a method described below.

The method for calculating the ratio [P1/P2] of the toner is as follows.

The ratio [P1/P2] can be calculated by dividing P1 by P2, where P1=Pa/Pb and P2=Pc/Pd, Pa and Pb respectively represent a maximum absorption peak intensity in the range of 2,843 cm⁻¹ or more and 2,853 cm⁻¹ or less and a maximum absorption peak intensity in the range of 1,713 cm⁻¹ or more and 1,723 cm⁻¹ or less in an FT-IR spectrum of the toner measured by an ATR method using Ge as an ATR crystal at an angle of incidence of infrared light of 45°, and Pc and Pd respectively represent a maximum absorption peak intensity in the range of 2,843 cm⁻¹ or more and 2,853 cm⁻¹ or less and a maximum absorption peak intensity in the range of 1,713 cm⁻¹ or more and 1,723 cm⁻¹ or less in an FT-IR spectrum of the toner measured by an ATR method using KRS5 as an ATR crystal at an angle of incidence of infrared light of 45°.

Note that each of the maximum absorption peak intensities Pa to Pd is the intensity of a peak itself determined by subtracting the effect of a base line from a maximum value of the FT-IR spectrum. Specifically, the maximum absorption peak intensity Pa is a value determined by subtracting the average of the absorption intensity at 3,050 cm⁻¹ and the absorption intensity at 2,600 cm⁻¹ from the maximum of the absorption peak intensity in the range of 2,843 cm⁻¹ or more and 2,853 cm⁻¹ or less. Similarly, the maximum absorption peak intensity Pb is a value determined by subtracting the average of the absorption intensity at 1,763 cm⁻¹ and the absorption intensity at 1,630 cm⁻¹ from the maximum of the absorption peak intensity in the range of 1,713 cm⁻¹ or more and 1,723 cm⁻¹ or less. The maximum absorption peak intensity Pc is a value determined by subtracting the average of the absorption intensity at 3,050 cm⁻¹ and the absorption intensity at 2,600 cm⁻¹ from the maximum of the absorption peak intensity in the range of 2,843 cm⁻¹ or more and 2,853 cm⁻¹ or less. The maximum absorption peak intensity Pd is a value determined by subtracting the average of the absorption intensity at 1,763 cm⁻¹ and the absorption intensity at 1,630 cm⁻¹ from the maximum of the absorption peak intensity in the range of 1,713 cm⁻¹ or more and 1,723 cm⁻¹ or less.

In the FT-IR spectra, the absorption peak in the range of 1,713 cm⁻¹ or more and 1,723 cm⁻¹ or less is a peak mainly attributable to stretching vibration of —CO— derived from a binder resin. Various peaks other than the above peak, such as a peak attributable to out-of-plane bending vibration of CH of an aromatic ring, are also detected as peaks derived from the binder resin. However, a large number of peaks are present in the range of 1,500 cm⁻¹ or less, and it is difficult to isolate only peaks derived from the binder resin. Thus, an accurate numerical value cannot be calculated. Therefore, the absorption peak in the range of 1,713 cm⁻¹ or more and 1,723 cm⁻¹ or less, which is easily isolated from other peaks, is used as a peak derived from the binder resin.

In the FT-IR spectra, the absorption peak in the range of 2,843 cm⁻¹ or more and 2,853 cm⁻¹ or less is a peak mainly attributable to stretching vibration (symmetry) of —CH₂— derived from a wax. Another peak attributable to in-plane bending vibration of CH₂ is also detected in the range of 1,450 cm⁻¹ or more and 1,500 cm⁻¹ or less as a peak derived from the wax. However, this peak overlaps with a peak derived from the binder resin, and it is difficult to isolate the peak derived from the wax. Therefore, the absorption peak in the range of 2,843 cm⁻¹ or more and 2,853 cm⁻¹ or less, which is easily isolated from other peaks, is used as a peak derived from the wax.

In determining Pa and Pc, the average of the absorption intensity at 3,050 cm⁻¹ and the absorption intensity at 2,600 cm⁻¹ is subtracted from the maximum of the absorption peak intensity in the range of 2,843 cm⁻¹ or more and 2,853 cm⁻¹ or less. Usually, no absorption peaks are observed around at 3,050 cm⁻¹ and around at 2,600 cm⁻¹. Accordingly, a base line intensity can be calculated by calculating the average of these two points.

In determining Pb and Pd, the average of the absorption intensity at 1,763 cm⁻¹ and the absorption intensity at 1,630 cm⁻¹ is subtracted from the maximum of the absorption peak intensity in the range of 1,713 cm⁻¹ or more and 1,723 cm⁻¹ or less. Usually, no absorption peaks are observed around at 1,763 cm⁻¹ and around at 1,630 cm⁻¹. Accordingly, a base line intensity can be calculated by calculating the average of these two points.

The maximum absorption peak intensities Pb and Pd derived from the binder resin and the maximum absorption peak intensities Pa and Pc derived from the wax correlate with the amounts of the binder resin and the wax, respectively. Accordingly, in the present invention, the abundance ratio of the wax to the binder resin is calculated by dividing the maximum absorption peak intensity derived from the wax by the maximum absorption peak intensity derived from the binder resin.

It has been found that, in order for a toner to become releasable from a fixing member, it is important that the wax be exuded in a fixing step to form a releasing layer between the fixing member and a toner layer. However, in the case of a high-speed machine such as a print-on demand (POD) system, since the melting time of the toner in the fixing step is short, the exudation time of the wax is also shortened and a sufficient releasing layer cannot be formed. As a result, unintentional winding of a recording medium during fixing tends to occur.

Therefore, in order to use a high-speed machine such as a POD system, it is necessary to add a wax in a large amount. As a result, a change in the amount of triboelectric charge due to embedding of inorganic fine particles in the surfaces of toner particles or detachment of the inorganic fine particles from the surfaces of toner particles may increase.

As a result of intensive studies conducted by the inventors of the present invention, it has been found that P1 correlates to the glossiness of an image and a property for preventing unintentional winding of a recording medium during fixing. It is believed that, by allowing a wax to be present in a large amount relative to the binder resin in the range from the toner surface to about a position of 0.3 μm in the thickness direction, even when a high-speed machine such as a POD system is used, the wax is rapidly melted in the fixing step and exhibits a releasing effect, thus improving the releasability between a fixing member and a toner layer. Specifically, P1 is preferably 0.10 or more and 0.70 or less, and more preferably 0.12 or more and 0.66 or less.

It has been found that, in the present invention, in order to exhibit the releasing effect in the fixing step, the state of the presence of the wax is important. Specifically, there is a correlation between the abundance ratio of the wax at a position of about 0.3 μm and an exudation behavior of the wax. Accordingly, in the present invention, the abundance ratio P1 of the wax at a position of about 0.3 μm is used as an index.

In order to control P1, a raw material toner may be surface-treated with hot air. Herein, the term “raw material toner” refers to toner particles before a surface treatment is conducted by a heat treatment. In order to increase P1, for example, the surface treatment temperature with hot air may be increased or the amount of wax added may be increased. On the other hand, P1 can be decreased by decreasing the surface treatment temperature with hot air, decreasing the amount of wax added, or externally adding inorganic fine particles to the raw material toner.

In order to improve the glossiness of an image and the property for preventing unintentional winding of a recording medium during fixing, it is important to control P1 in the above range. However, the wax is soft because the molecular weight of thereof is lower than that of the binder resin. Consequently, even in the case where P1 is controlled in the above range, for example, inorganic fine particles are embedded in toner particles through endurance, which may result in an increase in the change in the amount of triboelectric charge.

In the present invention, in order to exhibit stability of the amount of charging due to friction between the toner and the magnetic carrier, it is important to suppress embedding of inorganic fine particles fixed to the surfaces of toner particles. Specifically, there is a correlation between the abundance ratio of the wax at a position of about 1.0 μm and the suppression of the embedding of inorganic fine particles. Accordingly, in the present invention, the abundance ratio P2 of the wax at a position of about 1.0 μm is used as an index.

Although the mechanism is not clear, the inventors of the present invention assume as follows.

Regarding a change in the amount of charging due to friction with a magnetic carrier, it is important to suppress a change in the toner surface through endurance. Specifically, it is believed that the change in the toner surface can be suppressed by suppressing detachment and embedding of inorganic fine particles due to a stress in a developing device.

It is believed that not only the hardness on the toner surface but also the hardness of a lower layer located thereunder relates to the embedding of inorganic fine particles. For example, it is believed that even if the amount of wax present on the top surface layer of the toner is large, the inorganic fine particles are not embedded to the extent that the function thereof is lost as long as the lower layer located under the top surface layer is formed of a hard resin layer. Accordingly, it is believed that the abundance ratio P2 of the wax to the binder resin in the range from the toner surface to a position of about 1.0 μm in a depth direction is important. It is believed that, by controlling P2 in a specific range, the embedding of the inorganic fine particles can be suppressed to suppress a change in the amount of triboelectric charge. As described above, the abundance ratio P2 of the wax to the binder resin in the range from the toner surface to a position of about 1.0 μm is calculated from Pc and Pd determined by measuring the toner by an ATR method using KRS5 (n₂=2.4) as an ATR crystal at an angle of incidence of infrared light of 45° (P2=Pc/Pd). Specifically, P2 is preferably 0.05 or more and 0.35 or less, and more preferably 0.06 or more and 0.33 or less.

P2 can be controlled by changing the type and the amount of wax added and controlling the dispersion diameter of the wax in the toner in a specified range. In the case where a surface treatment with hot air is conducted, P2 can be controlled by changing the treatment conditions. The dispersion diameter of the wax in the toner can also be changed by, for example, internally adding inorganic fine particles in the preparation of toner particles.

Materials that can be used in the toner of the present invention will now be described.

Examples of the binder resin used in the toner include homopolymers of a styrene derivative such as polystyrene and polyvinyltoluene; styrene copolymers such as styrene-propylene copolymers, styrene-vinyltoluene copolymers, styrene-vinylnaphthalene copolymers, styrene-methyl acrylate copolymers, styrene-ethyl acrylate copolymers, styrene-butyl acrylate copolymers, styrene-octyl acrylate copolymers, styrene-dimethylaminoethyl acrylate copolymers, styrene-methyl methacrylate copolymers, styrene-ethyl methacrylate copolymers, styrene-butyl methacrylate copolymers, styrene-octyl methacrylate copolymers, styrene-dimethylaminoethyl methacrylate copolymers, styrene-vinyl methyl ether copolymers, styrene-vinyl ethyl ether copolymers, styrene-vinyl methyl ketone copolymers, styrene-butadiene copolymers, styrene-isoprene copolymers, styrene-maleic acid copolymers, and styrene-maleate copolymers; polymethyl methacrylate; polybutyl methacrylate; polyvinyl acetate; polyethylene; polypropylene; polyvinyl butyral; silicone resins; polyester resins; polyamide resins; epoxy resins; polyacrylic resins; rosin; modified rosin; terpene resins; phenolic resins; aliphatic or alicyclic hydrocarbon resins; and aromatic petroleum resins. These resins may be used alone or in combination of two or more resins.

Among these resins, polymers that are preferably used as the binder resin are styrene copolymers and resins having a polyester unit.

The term “polyester unit” refers to a moiety derived from a polyester. Examples of components constituting the polyester unit include divalent or higher alcohol monomer components and acid monomer components such as divalent or higher carboxylic acids, divalent or higher carboxylic acid anhydrides, and divalent or higher carboxylic acid esters.

Examples of the divalent or higher alcohol monomer components include the following compounds. Specifically, examples of the divalent alcohol monomer components include alkylene oxide adducts of bisphenol A, such as polyoxypropylene(2.2)-2,2-bis(4-hydroxyphenyl)propane, polyoxypropylene(3.3)-2,2-bis(4-hydroxyphenyl)propane, polyoxyethylene(2.0)-2,2-bis(4-hydroxyphenyl)propane, polyoxypropylene(2.0)-polyoxyethylene(2.0)-2,2-bis(4-hydroxyphenyl)propane, and polyoxypropylene(6)-2,2-bis(4-hydroxyphenyl)propane; ethylene glycol; diethylene glycol; triethylene glycol; 1,2-propylene glycol; 1,3-propylene glycol; 1,4-butanediol; neopentyl glycol; 1,4-butenediol; 1,5-pentanediol; 1,6-hexanediol, 1,4-cyclohexanedimethanol; dipropylene glycol; polyethylene glycol; polypropylene glycol; polytetramethylene glycol, bisphenol A, and hydrogenated bisphenol A.

Examples of the trivalent or higher alcohol monomer components include sorbit, 1,2,3,6-hexanetetrol, 1,4-sorbitan, pentaerythritol, dipentaerythritol, tripentaerythritol, 1,2,4-butanetriol, 1,2,5-pentanetriol, glycerol, 2-methylpropanetriol, 2-methyl-1,2,4-butanetriol, trimethylolethane, trimethylolpropane, and 1,3,5-trihydroxymethylbenzene.

Examples of the divalent carboxylic acid monomer component include aromatic dicarboxylic acids such as phthalic acid, isophthalic acid, and terephthalic acid, and anhydrides thereof; alkyl dicarboxylic acids such as succinic acid, adipic acid, sebacic acid, and azelaic acid, and anhydrides thereof; succinic acid substituted with an alkyl group or alkenyl group having 6 to 18 carbon atoms, and anhydrides thereof; and unsaturated dicarboxylic acids such as fumaric acid, maleic acid, and citraconic acid, and anhydrides thereof.

Examples of the trivalent or higher carboxylic acid monomer component include polyvalent carboxylic acids such as trimellitic acid, pyromellitic acid, and benzophenone tetracarboxylic acid, and anhydrides thereof.

Examples of other monomers include polyhydric alcohols such as oxyalkylene ethers of novolak phenolic resins.

In the case where the above binder resin is used, the glass transition temperature (Tg) of the binder resin is preferably 40° C. or higher and 90° C. or lower, and more preferably 45° C. or higher and 65° C. or lower from the standpoint of realizing a satisfactory storage property, low-temperature fixing property, and hot offset resistance.

Examples of the wax used in the toner include hydrocarbon waxes such as low-molecular-weight polyethylene, low-molecular-weight polypropylene, alkylene copolymers, microcrystalline wax, paraffin wax, and Fischer-Tropsch wax; oxides of hydrocarbon waxes such as oxidized polyethylene wax, and block copolymers thereof; waxes containing a fatty acid ester as a main component, such as carnauba wax; and waxes obtained by partially or completely deoxidizing a fatty acid ester, such as deoxidized carnauba wax.

Examples of the wax further include saturated straight-chain fatty acids such as palmitic acid, stearic acid, and montanic acid; unsaturated fatty acids such as brassidic acid, eleostearic acid, and parinaric acid; saturated alcohols such as stearyl alcohol, aralkyl alcohols, behenyl alcohol, carnaubyl alcohol, ceryl alcohol, and melissyl alcohol; polyhydric alcohols such as sorbitol; esters of a fatty acid such as palmitic acid, stearic acid, behenic acid, or montanic acid, and an alcohol such as stearyl alcohol, an aralkyl alcohol, behenyl alcohol, carnaubyl alcohol, ceryl alcohol, or melissyl alcohol; fatty acid amides such as linoleamide, oleamide, and lauramide; saturated fatty acid bisamides such as methylene bis-stearamide, ethylene bis-capramide, ethylene bis-lauramide, and hexamethylene bis-stearamide; unsaturated fatty acid amides such as ethylene bis-oleamide, hexamethylene bis-oleamide, N,N′-dioleyl adipamide, and N,N′-dioleyl sebacamide; aromatic bisamides such as m-xylene bis-stearamide and N,N′-distearyl isophthalamide; aliphatic metal salts (those generally referred to as “metallic soaps”) such as calcium stearate, calcium laurate, zinc stearate, and magnesium stearate; waxes composed of an aliphatic hydrocarbon wax obtained by grafting a vinyl monomer such as styrene or acrylic acid; partially esterified products of a fatty acid and a polyhydric alcohol, such as behenic monoglyceride; and hydroxyl group-containing methyl ester compounds obtained by hydrogenation of vegetable oils and fats.

Among these waxes, hydrocarbon waxes such as paraffin wax and Fischer-Tropsch wax are preferable from the standpoint of preventing toner scattering around a thin-line image and improving stress resistance of the toner.

The wax is preferably used in an amount of 0.5 parts by mass or more and 20 parts by mass or less relative to 100 parts by mass of the binder resin. The peak temperature of a maximum endothermic peak of the wax is preferably 45° C. or higher and 140° C. or lower because a satisfactory storage property, a low-temperature fixing property, and hot offset resistance of the toner can be realized. The peak temperature of a maximum endothermic peak of the wax is more preferably 75° C. or higher and 120° C. or lower from the standpoint of improving stress resistance of the toner.

Examples of colorants used in the toner include the following.

Examples of a black colorant include carbon black; and a colorant subjected to tone adjustment to black by using a yellow colorant, a magenta colorant, and a cyan colorant. A pigment may be used alone as the colorant. However, it is more preferable that a dye and a pigment be used in combination to improve the sharpness from the standpoint of the image quality of a full-color image.

As for a color pigment for a magenta toner, known compounds such as condensed azo compounds, diketopyrrolopyrrole compounds, anthraquinone, quinacridone compounds, basic dye lake compounds, naphthol compounds, benzimidazolone compounds, thioindigo compounds, and perylene compounds are used. Specific examples thereof include C. I. Pigment Red 57:1, 122, 150, 269, and 282 and C. I. Pigment Violet 19. As for a dye for a magenta toner, known compounds are used.

As for a color pigment for a cyan toner, for example, copper phthalocyanine pigments, such as C. I. Pigment Blue 15:3, in which a phthalocyanine skeleton is substituted with 1 to 5 phthalimidomethyl groups, are used. An example of a color dye for a cyan toner is C. I. Solvent Blue 70.

As for a color pigment for a yellow toner, compounds typified by condensed azo compounds, isoindolinone compounds, isoindoline compounds, anthraquinone compounds, azo metal complex methine compounds, and allylamide compounds are used. Specific examples thereof include C. I. Pigment Yellow 74, 93, 155, 180, and 185. Examples of a color dye for a yellow toner include C. I. Solvent Yellow 98 and 162.

The colorant is preferably used in an amount of 0.1 parts by mass or more and 30 parts by mass or less relative to 100 parts by mass of the binder resin.

If necessary, a charge control agent may be incorporated in the toner. Known compounds can be used as the charge control agent incorporated in the toner. In particular, it is preferable to use colorless metal compounds of an aromatic carboxylic acid, in which the speed of triboelectric charging of the toner is high and a constant amount of triboelectric charge can be stably held.

Examples of a negative charge control agent include metal compounds of salicylic acid, metal compounds of naphthoic acid, metal compounds of dicarboxylic acid, polymer-type compounds having a sulfonic acid or a carboxylic acid in a side chain thereof, polymer-type compounds having a sulfonic acid salt or an esterified sulfonic acid in a side chain thereof, polymer-type compounds having a carboxylic acid salt or an esterified carboxylic acid in a side chain thereof, boron compounds, urea compounds, silicon compounds, and calixarenes. Examples of a positive charge control agent include quaternary ammonium salts, polymer-type compounds having the above quaternary ammonium salt in a side chain thereof, guanidine compounds, and imidazole compounds. The charge control agent may be added to the toner particles either internally or externally. The charge control agent is preferably added in an amount of 0.2 parts by mass or more and 10 parts by mass or less relative to 100 parts by mass of the binder resin.

The toner of the present invention may contain inorganic fine particles as an external additive for the purpose of improving fluidity and stabilizing durability of the toner. Examples of the inorganic fine particles include silica, titanium oxide, and aluminum oxide fine particles. The inorganic fine particles may be hydrophobized with a hydrophobizing agent such as a silane compound, a silicone oil, or a mixture thereof. In order to improve fluidity, the inorganic fine particles used as an external additive preferably have a BET specific surface area of 50 m²/g or more and 400 m²/g or less. On the other hand, in order to stabilize durability, the inorganic fine particles preferably have a BET specific surface area of 10 m²/g or more and 50 m²/g or less. In order to achieve both improvement in fluidity and stabilization of durability, a plurality of types of inorganic fine particles having BET specific surface areas in the above ranges may be use in combination. The inorganic fine particles added as an external additive are preferably used in an amount of 0.1 parts by mass or more and 5.0 parts by mass or less relative to 100 parts by mass of the toner particles. A known mixer such as a Henschel mixer can be used for mixing the toner particles and the external additive.

From the standpoint of controlling the ratio P1/P2, the toner particles may contain inorganic fine particles as an internal additive. Examples of the inorganic fine particles that can be used as an internal additive include silica, titanium oxide, and aluminum oxide fine particles. The inorganic fine particles may be hydrophobized with a hydrophobizing agent such as a silane compound, a silicone oil, or a mixture thereof. The inorganic fine particles used as an internal additive preferably have a BET specific surface area of 10 m²/g or more and 400 m²/g or less. The inorganic fine particles added as an internal additive are preferably used in an amount of 0.5 parts by mass or more and 5.0 parts by mass or less relative to 100 parts by mass of the toner particles. It is believed that dispersibility of the wax is improved in the case where inorganic fine particles are incorporated as an internal additive in the toner particles.

The reason why dispersibility of the wax is improved by using the inorganic fine particles as an internal additive is believed to be as follows. In general, binder resins are relatively hydrophilic whereas waxes are highly hydrophobic. Therefore, in the case where the toner is produced by the pulverization method, a binder resin and a wax are not easily mixed in melt-kneading the binder resin, the wax, etc. However, in the case where inorganic fine particles are present in the melt-kneading, the inorganic fine particles, which are solid, are dispersed in the binder resin by a mechanical shear. In the case where the inorganic fine particles have been hydrophobized, since the highly hydrophobic inorganic fine particles have a high compatibility with the wax, the wax is present around the inorganic fine particles. As a result, the wax becomes easily dispersed in the binder resin. In addition, in the case where the toner is produced by the pulverization method, when inorganic fine particles are present in melt-kneading the binder resin, the wax, etc., the viscosity of the resulting melt-kneaded product is increased and a shear is more easily applied to the melt-kneaded product. Consequently, dispersibility of the wax in the binder resin is easily improved.

Examples of the method for producing toner particles include a pulverization method including melt-kneading a binder resin and a wax, cooling the resulting kneaded product, and then pulverizing and classifying the kneaded product; a suspension granulation method including introducing a solution prepared by dissolving or dispersing a binder resin and a wax in a solvent in an aqueous medium to cause suspension and granulation, and removing the solvent to obtain toner particles; a suspension polymerization method including dispersing a polymerizable monomer composition containing a polymerizable monomer, a wax, a colorant, etc. in an aqueous medium, and conducting a polymerization reaction to prepare toner particles; and an emulsion aggregation method including a step of forming fine particle aggregates by aggregating polymer fine particles and a wax and an aging step of conducting fusion of fine particles in the fine particle aggregates to obtain toner particles.

The procedure of producing a toner by the pulverization method will be described below. First, in a raw material mixing step, predetermined amounts of a binder resin, a wax and, as required, other components such as a colorant, a charge control agent, and inorganic fine particles are weighed, combined, and mixed. Examples of a mixing apparatus include a double cone mixer, a V-type mixer, a drum-type mixer, a super mixer, a Henschel mixer, a Nauta mixer, and MECHANO HYBRID (produced by NIPPON COKE & ENGINEERING CO., LTD.). Next, in a melt-kneading step, the resulting mixed material is melt-kneaded so as to disperse the wax etc. in the binder resin. In this step, a batch-type kneader such as a pressure kneader or a Banbury mixer, or a continuous kneader may be used. A single-screw or twin-screw extruder has been mainly used because of the advantage of continuous production. Examples of the extruder include a KTK twin-screw extruder (produced by Kobe Steel, Ltd.), a TEM twin screw extruder (produced by TOSHIBA MACHINE CO., LTD.), a PCM extruder (produced by Ikegai Corp.), a twin-screw extruder (produced by KCK), a co-kneader (produced by Buss), and KNEADEX (produced by NIPPON COKE & ENGINEERING CO., LTD.). Furthermore, a resin composition obtained by the melt-kneading may be rolled with a two-roll mill or the like. Subsequently, a cooling step of cooling the resin composition with water or the like may be conducted.

Next, in a pulverization step, the resulting resin composition is pulverized to have a desired particle diameter. In the pulverization step, after coarse grinding is conducted with a grinding machine, e.g., a crusher, a hammer mill, or a feather mill, fine pulverization is further conducted with Kryptron System (produced by Kawasaki Heavy Industries Ltd.), Super Roater (produced by NISSHIN ENGINEERING INC.), Turbo Mill (produced by FREUND-TURBO CORPORATION), or a fine pulverizer using an air jet system to obtain a pulverized product. Subsequently, if necessary, a classification step is conducted by using a classifier or a sieving machine, such as Elbow-Jet using an inertial classification system (produced by Nittetsu Mining Co., Ltd.), Turboplex using a centrifugal classification system (produced by Hosokawa Micron Corporation), TSP separator (produced by Hosokawa Micron Corporation), or Faculty (produced by Hosokawa Micron Corporation). Furthermore, after pulverization, a surface treatment such as a spheroidizing treatment of the toner particles may also be optionally performed using Hybridization System (produced by NARA MACHINERY CO., LTD.), Mechanofusion system (produced by Hosokawa Micron Corporation), or Faculty (produced by Hosokawa Micron Corporation).

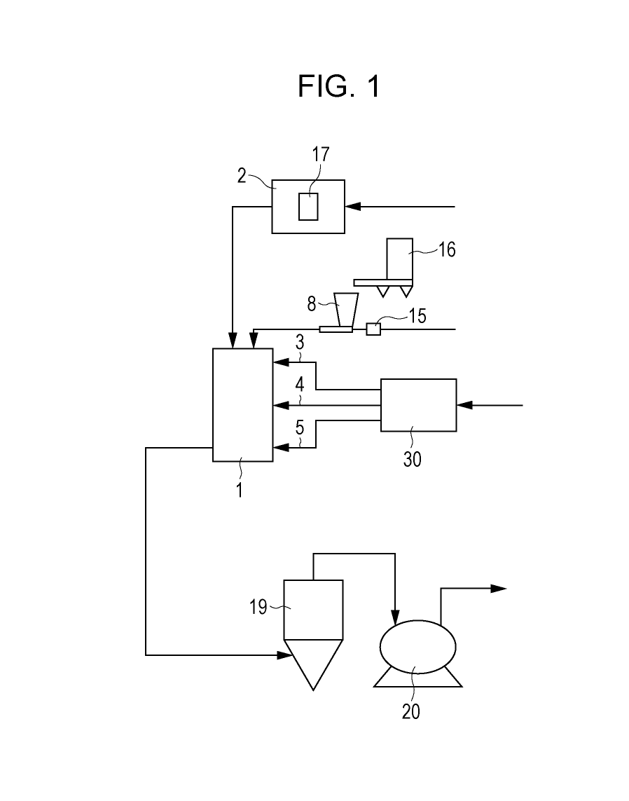

In order to obtain toner particles used in the toner of the present invention, after the pulverized product (raw material toner) is obtained, a surface treatment may be conducted using a heat treatment apparatus. FIG. 1 illustrates a flow for conducting a heat treatment of a pulverized product using a heat treatment apparatus.

A hot-air supply unit 2, a raw material supply unit 8, and cold-air supply units 3, 4, and 5 are arranged at the upstream of a heat treatment apparatus 1. A bag (toner collection unit) 19 and a blower 20 are arranged at the downstream of the heat treatment apparatus 1.

The raw material supply unit 8 supplies a raw material toner to a toner treatment space in the heat treatment apparatus 1 by compressed gas. The toner treatment space is a substantially cylindrical space in a main body of the heat treatment apparatus, and a heat treatment of the raw material toner is conducted in this space. A compressed gas supply unit 15 is arranged at the downstream of a feeder 16 so as to feed a constant amount of the raw material toner to the toner treatment space.

The hot-air supply unit 2 heats the outside air using a heater 17 provided inside thereof and supplies hot air to the toner treatment space. The raw material toner is spheroidized by this hot air in the toner treatment space. The cold-air supply units 3, 4, and 5 are connected to the main body of the heat treatment apparatus 1 for the purpose of cooling the heat-treated toner. Cold air is supplied from a cold-air supply device 30 to the cold-air supply units 3, 4, and 5. The toner that has been heat-treated in the toner treatment space is collected by the toner collection unit 19. As the toner collection unit 19, for example, a cyclone or a double-clone is used. The hot air that has been used in the heat treatment of the raw material toner is suctioned by the blower 20 functioning as a suction discharge unit and is discharged to the outside of the system of the heat treatment apparatus 1.

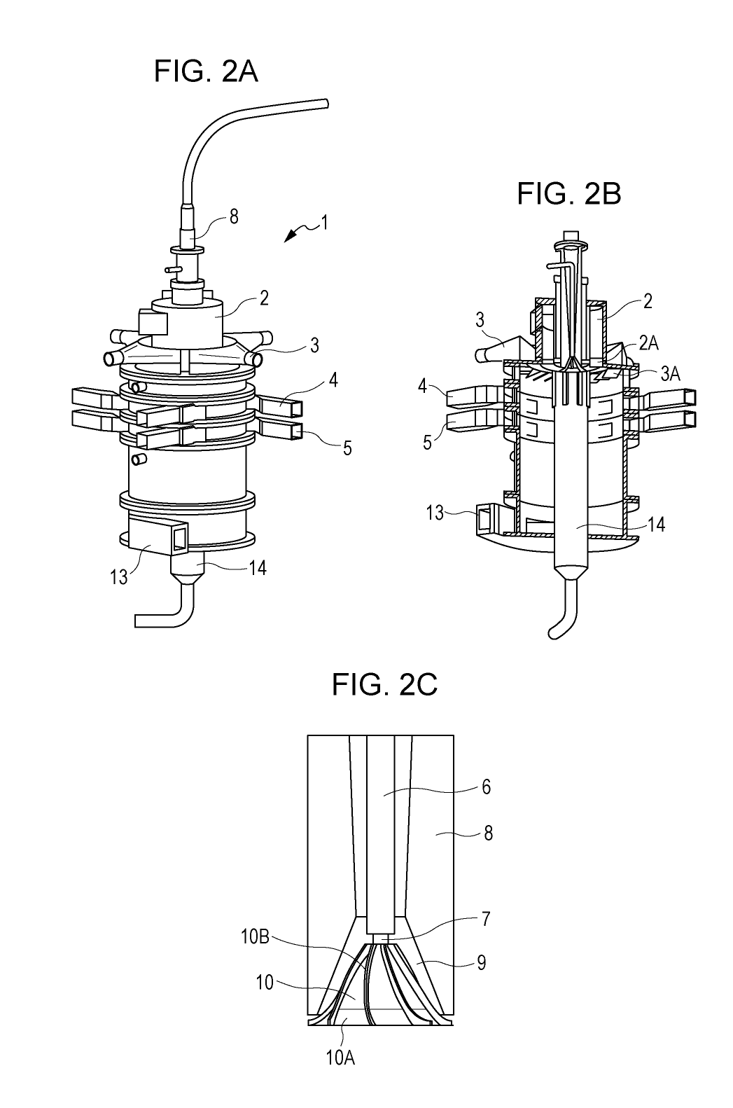

Next, a heat treatment apparatus will be described. FIGS. 2A to 2C are views illustrating an example of the heat treatment apparatus. The heat treatment apparatus is designed so that the maximum diameter of the outer circumference of the apparatus is 500 mm, and the height from the bottom surface of the apparatus to a top plate (an outlet of a powder introducing tube) is about 1,200 mm. FIG. 2A illustrates the appearance of the heat treatment apparatus. FIG. 2B illustrates the inner structure of the heat treatment apparatus. FIG. 2C is an enlarged view of an outlet portion of a raw material supply unit 8. Note that the apparatus structure and operating conditions of the apparatus described below are determined on the assumption that the apparatus has the dimensions described above.

The raw material supply unit 8 includes a first nozzle 9 extending in the radial direction and a second nozzle 10 arranged inside the first nozzle 9. The flow rate of a raw material toner supplied to the raw material supply unit 8 is accelerated by compressed gas supplied from the compressed gas supply unit 15, and the raw material toner passes through a space formed between the first nozzle 9 and the second nozzle 10, which are provided at the outlet portion of the raw material supply unit 8, and is ejected annularly toward the outside in the circumferential direction of the toner treatment space in the apparatus.

A first tubular member 6 and a second tubular member 7 are provided in the raw material supply unit 8, and the compressed gas is also supplied to each of the tubular members 6 and 7. The compressed gas passing through the first tubular member 6 passes through the space formed between the first nozzle 9 and the second nozzle 10. The second tubular member 7 penetrates through the second nozzle 10, and the compressed gas is ejected inside the second nozzle 10 from the outlet portion of the second tubular member 7 toward the inner surface of the second nozzle 10. A plurality of ribs 10B are provided on the outer peripheral surface of the second nozzle 10. These ribs 10B are arranged in a curved manner toward a direction of the flow of the hot air, which is supplied from a hot-air supply unit 2 described below. In a raw material flow path extending from the upstream portion of the raw material supply unit 8 to the first nozzle 9, the diameter of a portion of the raw material supply unit 8, the portion being connected to the first nozzle 9, is designed to be smaller than the diameter of the upstream end of the raw material supply unit 8. That is, the second nozzle 10 is arranged so as to diverge from a portion thereof connected to the second tubular member 7 toward a direction of the outlet portion. This is because the flow rate of supplied toner particles is once accelerated at an entrance of the first nozzle 9, and thus dispersion of the raw material toner can be further assisted. Furthermore, at an end in the direction of the outlet portion, the angle of the divergence is further changed to form a turn-up portion 10A that extends in the radial direction.

In the heat treatment apparatus illustrated in FIGS. 2A to 2C, the hot-air supply unit 2 is annularly provided at a position close to the outer peripheral surface of the raw material supply unit 8 or at a position distant from the outer peripheral surface of the raw material supply unit 8 in the horizontal direction. Furthermore, a first cold-air supply unit 3, a second cold-air supply unit 4, and a third cold-air supply unit 5 for cooling the heat-treated toner and preventing coalescence and fusion of toner particles due to a temperature increase in the apparatus are arranged at the outside and the downstream side of the hot-air supply unit 2. The hot-air supply unit 2 may be annularly provided at a position distant from the outer peripheral portion of the raw material supply unit 8 in the horizontal direction. In this case, it is possible to prevent a phenomenon that the outlet portion of the first nozzle 9 and the second nozzle 10 is heated by the supplied hot air, and toner particles ejected from the outlet portion are melted and adhered to each other.

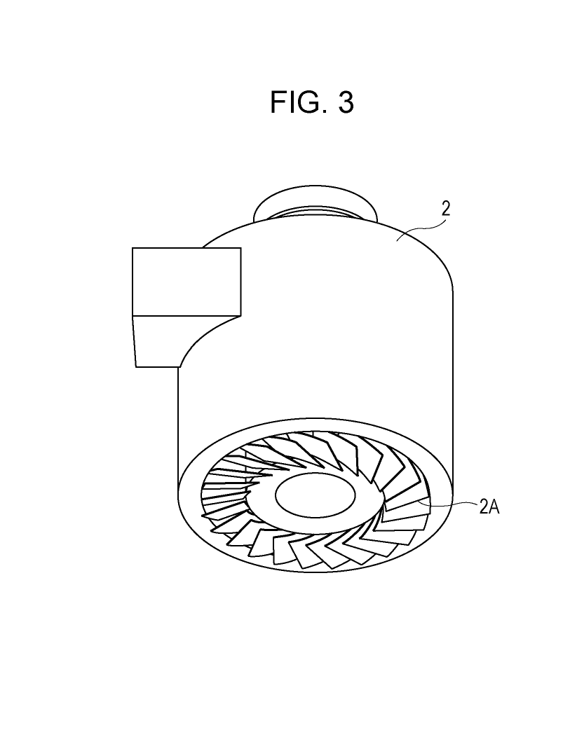

FIG. 3 is a partial cross-sectional perspective view illustrating an example of a hot-air supply unit 2 and an air flow-adjusting portion 2A. As illustrated in FIG. 3, the air flow-adjusting portion 2A for supplying hot air into the apparatus in an inclined and rotary manner is arranged on the outlet portion of the hot-air supply unit 2. The air flow-adjusting portion 2A includes a louver having a plurality of blades. Hot air supplied from the hot-air supply unit 2 having a cylindrical shape to the toner treatment space is inclined by the louver of the air flow-adjusting portion 2A and rotated in the toner treatment space. The raw material toner fed by the raw material supply unit 8 rotates with the flow of the hot air. The raw material toner is heat-treated in the toner treatment space while rotating, whereby heat is substantially uniformly applied to each of the toner particles. Consequently, toner particles having a sharp circularity distribution and a sharp particle size distribution can be obtained.

The number and the angles of blades of the louver of the air flow-adjusting portion 2A can be appropriately adjusted in accordance with the type of raw material and the amount of raw material to be treated. Regarding the angle of inclination of each of the blades of the louver in the air flow-adjusting portion 2A, the angle of a main surface of each blade with respect to the vertical direction is preferably 20 to 70 degrees, and more preferably 30 to 60 degrees. When the angle of inclination of the blade is within the above range, a decrease in the wind speed in the vertical direction can be suppressed while hot air is appropriately rotated in the apparatus. As a result, even when the amount of raw material to be treated is increased, coalescence of toner particles is prevented, and the frequency of the formation of toner particles having a circularity of 0.990 or more, which adversely affect the cleanability, is also suppressed. In addition, the retention of heat on the upper portion of the apparatus is prevented, and this is also efficient in terms of production energy.

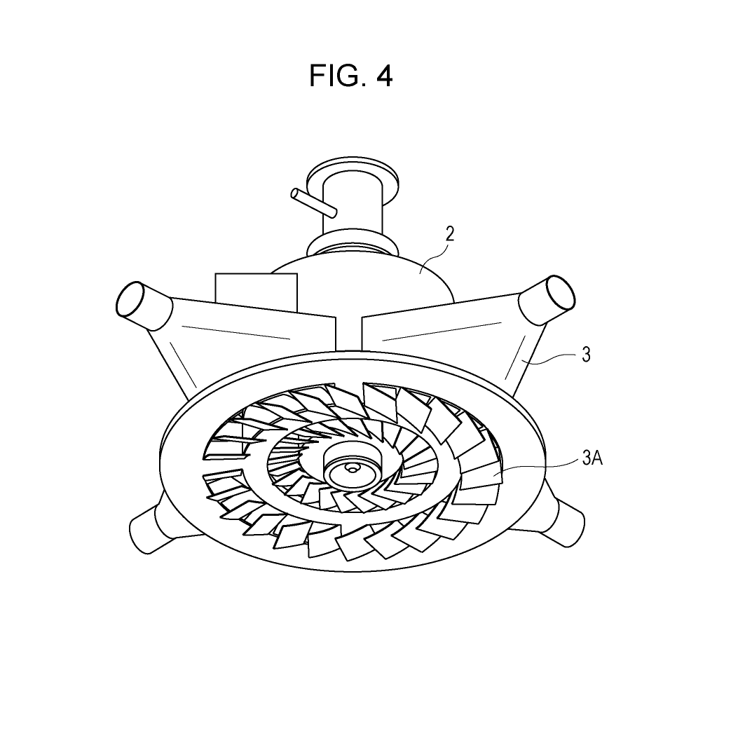

The heat treatment apparatus may include a cold-air supply unit. FIG. 4 is a partial cross-sectional perspective view illustrating an example of a first cold-air supply unit 3 and an air flow-adjusting portion 3A. As illustrated in FIG. 4, the air flow-adjusting portion 3A, in which a plurality of blades of a louver are arranged at certain intervals in an inclined manner, is arranged on the outlet portion of the first cold-air supply unit 3 so that cold air is rotated in the toner treatment space in the apparatus. The inclination of the louver of the air flow-adjusting portion 3A is adjusted so that the air is rotated in a direction substantially the same as the rotation direction of the hot air supplied from the hot-air supply unit 2 described above (the direction in which the rotation of the raw material toner in the toner treatment space is maintained). This structure further increases the rotating force of the hot air and suppresses an increase in the temperature in the toner treatment space, thus preventing fusion of toner particles on the outer peripheral portion in the apparatus and coalescence of the toner particles.

The number and the angles of blades of the louver of the air flow-adjusting portion 3A of the first cold-air supply unit 3 can also be appropriately adjusted in accordance with the type of raw material and the amount of raw material to be treated. Regarding the angle of inclination of each of the blades of the louver in first cold-air supply unit 3, the angle of a main surface of each blade with respect to the vertical direction is preferably 20 to 70 degrees, and more preferably 30 to 60 degrees. When the angle of inclination of the blade is within the above range, the flow of hot air and the toner particles in the toner treatment space in the apparatus is not disturbed, and the retention of heat on the upper portion of the apparatus is also prevented.

Besides the cold-air supply unit described above, at least one cold-air supply unit may be provided on the lower side of the hot-air supply unit so that cold air is supplied in a divided manner in the vertical direction of the apparatus when cold air is supplied to the inside of the apparatus. For example, the apparatus illustrated in FIG. 2A is configured so that cold air is introduced from each of the first cold-air supply unit 3, the second cold-air supply unit 4, and the third cold-air supply unit 5 to the toner treatment space in a divided manner from four directions. This structure aims to easily uniformly control the flow of wind in the apparatus. The amounts of cold air flows in four divided introduction paths can be independently controlled. The second cold-air supply unit 4 and the third cold-air supply unit 5 may be arranged on the lower side of the first cold-air supply unit 3, and may be configured to supply cold air from the outer peripheral portion of the apparatus from a horizontal and tangential direction.

A cylindrical pole 14 extending from a bottom portion of the apparatus to near the second nozzle 10 is provided in an axial central portion of the apparatus. Cold air is introduced also into the pole 14, and the cold air is discharged from an outer peripheral surface of the pole 14. An outlet portion of the pole 14 is configured so that the cold air is discharged in a direction substantially the same as the rotation direction of the hot air supplied from the hot-air supply unit 2 and the cold air supplied from the first cold-air supply unit 3, the second cold-air supply unit 4, and the third cold-air supply unit 5 (the direction in which the rotation of the raw material toner in the toner treatment space is maintained). Examples of the shape of the outlet portion of the pole 14 include a slit shape, a louver shape, a porous plate shape, and a mesh shape.

Furthermore, in order to prevent fusion of toner particles, a cooling jacket is provided around each of the outer peripheral portion of the raw material supply unit 8, the outer peripheral portion of the apparatus, and the inner peripheral portion of the hot-air supply unit 2. An antifreeze such as cooling water or ethylene glycol may be introduced in the cooling jacket.

The hot air supplied into the apparatus preferably has a temperature C (° C.) in the outlet portion of the hot-air supply unit 2 of 100≦C≦450. When the temperature of the hot air in the outlet portion of the hot-air supply unit 2 is within the above range, a spheroidizing treatment can be performed so that the particle diameter and the circularity of the toner particles are substantially uniform while preventing fusion and coalescence of the toner particles due to overheating.

A temperature E (° C.) in each of the first cold-air supply unit 3, the second cold-air supply unit 4, and the third cold-air supply unit 5 is preferably −20≦E≦40. When the temperature in each of the cold-air supply units is within the above range, the toner particles can be appropriately cooled and fusion and coalescence of the toner particles can be prevented.

The cooled toner particles pass through a toner discharge opening 13 and are then collected. A blower 20 is arranged at the downstream side of the toner discharge opening 13, and toner particles are suctioned and discharged by the blower 20. The toner discharge opening 13 is arranged at a bottom portion of the apparatus so as to be horizontal to the outer peripheral portion of the apparatus. The discharge opening 13 is connected in a direction in which the flow caused by the rotation from the upstream portion of the apparatus to the discharge opening 13 is maintained.

In the heat treatment apparatus, a total amount QIN of the flow of the compressed gas, hot air, and cold air, all of which are supplied to the apparatus, and an amount QOUT of gas suctioned by the blower 20 are preferably adjusted so as to satisfy the relationship QIN≦QOUT. When the relationship QIN≦QOUT is satisfied, the pressure in the apparatus is a negative pressure. Accordingly, the ejected toner particles are easily discharged outside the apparatus, thus preventing the toner particles from excessively receiving heat. As a result, an increase in coalesced toner particles and fusion of the toner particles in the apparatus can be prevented.

The toner of the present invention may be used as a one-component developer. Alternatively, in order to further improve dot reproducibility and to obtain an image that is stable for a long period of time, the toner of the present invention may be mixed with a magnetic carrier and used as a two-component developer. The magnetic carrier used in combination with the toner has a true specific gravity preferably 3.2 g/cm³ or more and 4.9 g/cm³ or less, and more preferably 3.4 g/cm³ or more and 4.2 g/cm³ or less. When the true specific gravity of the magnetic carrier is within the above range, a load applied during stirring of the developer in a developing device is decreased, and toner-spent during endurance at a high coverage (printing ratio: 40% or more) is suppressed. Furthermore, the occurrence of fogging in a non-image area caused by a decrease in the amount of triboelectric charge of the toner is also suppressed.

The magnetic carrier used in combination with the toner of the present invention preferably has a volume-distribution-based 50% particle diameter (D50) of 30.0 μm or more and 70.0 μm or less. When the 50% particle diameter D50 of the magnetic carrier is within the above range, the amount of charge of the toner is stably obtained. Regarding the amount of magnetization of the magnetic carrier used in combination with the toner of the present invention, the intensity of magnetization measured under a magnetic field of 1,000 oersted (σ1000) is preferably 15 Am²/kg (emu/g) or more and 65 Am²/kg (emu/g) or less from the standpoint of maintaining the developing property and stability during endurance.

Examples of the magnetic carrier include particles of a metal such as iron, lithium, calcium, magnesium, nickel, copper, zinc, cobalt, manganese, chromium, or a rare earth; alloy particles and oxide particles thereof; magnetic materials such as ferrite; and magnetic material-dispersed resin carriers (so-called resin carriers) containing the magnetic material and a binder resin that holds the magnetic material in a dispersed state.

In the case where the toner is mixed with the magnetic carrier and is used as a two-component developer, good results are obtained when the toner concentration in the developer is 2% by mass or more and 15% by mass or less, and preferably 4% by mass or more and 13% by mass or less.

An image forming method in an electrophotographic apparatus will now be described. An electrophotographic photosensitive member (image bearing member) is driven to rotate at a certain peripheral speed and the surface thereof is positively or negatively charged by a charging device during rotation (charging step). Subsequently, the electrophotographic photosensitive member is subjected to exposure (such as slit exposure or laser beam scanning exposure) by an image exposure device. Consequently, an electrostatic latent image corresponding to an exposed image is formed on the surface of the photosensitive member (latent image forming step). A toner is supplied from a development sleeve to the electrophotographic photosensitive member bearing the electrostatic latent image to develop a toner image (developing step). The toner image is transferred to a transfer material by a transfer device (transfer step). The toner image may be transferred to the transfer material either directly or through an intermediate transfer member. After the transfer material is separated from the surface of the photosensitive member, the toner image is fixed to the transfer material by applying heat and/or pressure supplied from an image fixing device and the transfer material is output as a duplicate to the outside of the apparatus. After the transfer of the image, a transfer residual toner on the surface of the electrophotographic photosensitive member is removed by a cleaning device (cleaning step).

The toner of the present invention may be used in an image forming method including a blade cleaning step, in which cleaning is performed by bringing a blade into contact with the surface of an image bearing member. For example, in the case where a toner having a large average circularity and including a high proportion of toner particles having a circularity of 0.990 or more, such as a toner including toner particles obtained by a suspension polymerization method, is used, the toner easily passes through a gap between the image bearing member and the cleaning blade, and thus the cleanability is not good. In such a case, the initial cleanability can be improved by using an image bearing member having a large elastic deformation rate to increase an average contact surface pressure of a contact nip portion between the image bearing member and the cleaning blade. However, after endurance, the cleanability tends to decrease because of vibration of the blade.

In contrast, in the case where the toner of the present invention is used, since the proportion of particles having a circularity of 0.990 or more is small, the cleanability is good and an image bearing member having a relatively low elastic deformation rate can be used. In general, when the elastic deformation rate of the image bearing member is low, the cleanability decreases, but the durability of the image bearing member is good. In the case where the toner of the present invention is used, an image bearing member having a relatively low elastic deformation rate can be used, and thus stable cleanability can be obtained for a long period of time. Furthermore, the toner of the present invention has a higher average circularity than that of the toner obtained by the known pulverization method. Therefore, the toner of the present invention is excellent in terms of transferability and developing property in addition to cleanability.

The elastic deformation rate of the surface of the image bearing member is preferably 40% or more and 70% or less. When the elastic deformation rate of the surface of the image bearing member is within the above range, the surface of the image bearing member is not easily worn and is highly durable. In addition, vibration of the cleaning blade and turning up of the cleaning blade due to an increase in frictional resistance of the cleaning blade do not tend to occur. The elastic deformation rate of the surface of the image bearing member is more preferably 45% or more and 60% or less.

The contact surface pressure between the cleaning blade and the photosensitive member is preferably 10 gf/cm² or more and 30 gf/cm² or less. In order that a transfer residual toner on the image bearing member does not easily pass through a gap with the cleaning blade, it is preferable to increase the contact surface pressure between the cleaning blade and the photosensitive member. However, if the pressure between the cleaning blade and the image bearing member is excessively high, during endurance, particularly in a high-temperature high-humidity environment (temperature: 32.5° C., humidity: 80% RH), the frictional resistance between the cleaning blade surface and the image bearing member surface increases and an excessive load is applied to the cleaning blade. If an excessive load is applied to the cleaning blade, chipping of an edge of the cleaning blade or turning up of the cleaning blade may occur, and defective cleaning may be caused by the chipping of an edge or turning up of the cleaning blade. This phenomenon tends to occur significantly with an increase in the friction coefficient μ of the material of the outermost surface layer on the electrophotographic photosensitive member because the frictional resistance between the cleaning blade and the electrophotographic photosensitive member increases.

The surface of the image bearing member may be composed of a resin cured by polymerizing or cross-linking a compound having a polymerizable functional group (hereinafter may be referred to as “curable resin”). In such a case, the durability of the image bearing member is further improved. An example of a cross-linking method is a method including incorporating a monomer or an oligomer having a polymerizable functional group in a coating material used in preparation of the image bearing member, forming a film by applying the coating material, drying the film, and then causing polymerization of the film to proceed by heating and application of radiation or an electron beam.

Even when the average contact surface pressure of the contact nip portion of the cleaning blade is increased, an increase in frictional resistance of the cleaning blade can be suppressed by combining the above image bearing member and the toner of the present invention. As a result, vibration of the cleaning blade and turning up of the cleaning blade can be suppressed and corona products (NOₓ and ozone) can be scraped off by a discharge current between a charging roller and the image bearing member. Consequently, image deletion due to the corona products can be suppressed.

The surface containing the curable resin may have a charge transport function or have no charge transport function. In the case where the outermost surface layer containing a curable resin has the charge transport function, the outermost surface layer is treated as a part of a photosensitive layer. In the case where the outermost surface layer has no charge transport function, the outermost surface layer is referred to as a protective layer (or a surface protective layer) as described below, and is distinguished from the photosensitive layer.

Regarding a layer structure of the photosensitive layer of the image bearing member, it is possible to use any of a normal stacked layer structure in which a charge generation layer and a charge transport layer are stacked in that order from an electrically conductive support side, a reverse stacked layer structure in which a charge transport layer and a charge generation layer are stacked in that order from an electrically conductive support side, and a structure including a single layer in which a charge generation material and a charge transport material are dispersed.

In the photosensitive layer composed of a single layer, generation and movement of a photocarrier are conducted in the same layer, and the photosensitive layer itself functions as the surface layer. In contrast, the photosensitive layer composed of stacked layers has a structure in which a charge generation layer which generates a photocarrier and a charge transport layer in which the generated carrier moves are stacked.

The normal stacked layer structure in which a charge generation layer and a charge transport layer are stacked in that order from an electrically conductive support side is the most preferable.

In this case, the image bearing member may include a charge transport layer functioning as the outermost surface layer composed of a single layer containing a curable resin. Alternatively, the image bearing member may include a charge transport layer having a stacked layer structure including a non-curable first layer and a curable second layer that functions as the outermost surface layer. Both of these image bearing members are preferable.

In both cases of the single layer and the stacked layers, a protective layer may be provided on the photosensitive layer. In this case, the protective layer may contain the curable resin.

Methods for measuring properties of the toner of the present invention and raw materials of the toner will be described below.

Method for Measuring Average Circularity of Toner, Percentage of the Number of Particles Having Equivalent Circle Diameter of 0.50 μm or More and Less than 1.98 μm, and Percentage of the Number of Particles Having Circularity of 0.990 or More

The average circularity of the toner of the present invention, the percentage of the number of particles having an equivalent circle diameter of 0.50 μm or more and less than 1.98 μm, and the percentage of the number of particles having a circularity of 0.990 or more are measured with a flow particle image analyzer “FPIA-3000” (produced by SYSMEX CORPORATION).

A specific measuring method is as follows. First, about 20 mL of ion-exchange water, from which solid impurities and the like have been removed in advance, is put in a glass container. As a dispersing agent, about 0.2 mL of diluted solution prepared by diluting Contaminon N (a 10% by mass aqueous solution of a neutral detergent for washing a precision measuring device, containing a nonionic surfactant, an anionic surfactant, and an organic builder, having a pH of 7, and produced by Wako Pure Chemical Industries, Ltd.) with ion-exchange water by a factor of about three on a mass basis is added to the ion-exchange water. Furthermore, about 0.02 g of a measurement sample is added thereto and a dispersion treatment is conducted for two minutes using an ultrasonic dispersing device to prepare a dispersion liquid for measurement. In this step, cooling is appropriately performed such that the temperature of the dispersion liquid becomes 10° C. or higher and 40° C. or lower. A desktop ultrasonic cleaning and dispersing device having an oscillation frequency of 50 kHz and an electrical output of 150 W (for example, VS-150 (produced by VELVO-CLEAR)) is used as the dispersing device. A predetermined amount of ion-exchange water is put in a water tank of the device and about 2 mL of Contaminon N is added to this water tank.

In the measurement, the above-described flow particle image analyzer equipped with a standard objective lens (10 times) is used, and PARTICLE SHEATH (PSE-900A) (produced by SYSMEX CORPORATION) is used as a sheath liquid. The dispersion liquid prepared in accordance with the procedure described above is introduced into the flow particle image analyzer, and 3,000 toner particles are measured according to a total count mode in an HPF measurement mode. A binarization threshold value in particle analysis is set to 85% and a range of the particle diameter to be analyzed is specified. Thus, the proportion (%) of the number of particles and the average circularity of particles within the specified range can be calculated. Regarding the average circularity of the toner, the range of the particle diameter to be analyzed on an equivalent circle diameter basis is set to 1.98 μm or more and less than 200.00 μm, and the average circularity of the toner in this range is determined. Regarding the proportion of particles having a circularity of 0.990 or more and 1.000 or less, the range of the particle diameter to be analyzed on an equivalent circle diameter basis is set to 1.98 μm or more and less than 200.00 μm, and the proportion (%) of the number of particles is calculated from the circularity distribution of particles included in the range. Regarding the proportion of particles (small particles) having an equivalent circle diameter of 0.50 μm or more and less than 1.98 μm, the range of the particle diameter to be analyzed on an equivalent circle diameter basis is set to 0.50 μm or more and less than 1.98 μm, and the ratio (%) of the number of particles included in the range of 0.50 μm or more and less than 1.98 μm to the number of particles included in the range of 0.50 μm or more and less than 200.00 μm is calculated.

In the measurement, automatic focal point adjustment is conducted prior to the start of the measurement using standard latex particles (for example, a sample prepared by diluting RESEARCH AND TEST PARTICLES Latex Microsphere Suspensions 5200A produced by Duke Scientific Corporation with ion-exchange water). Thereafter, the focal point adjustment may be conducted every two hours after the start of the measurement.

In Examples of the present application, a flow particle image analyzer which had been calibrated by SYSMEX CORPORATION and for which a calibration certificate had been issued by SYSMEX CORPORATION was used.

### Method for Calculating P1 and P2

FT-IR spectra are measured by an ATR method using a Fourier transform infrared spectrophotometer (Spectrum One, produced by PerkinElmer Inc.) equipped with a universal ATR sampling accessory. A specific measurement procedure and methods for calculating P1, P2, and the ratio [P1/P2] determined by dividing P1 by P2 are as follows.

The angle of incidence of infrared light is set to 45°. A germanium (Ge) ATR crystal (refractive index=4.0) and a KRS5 ATR crystal (refractive index=2.4) are used as ATR crystals. Other conditions are as follows:

### Range

Start: 4,000 cm⁻¹

End: 600 cm⁻¹ (Ge ATR crystal)
400 cm⁻¹ (KRS5 ATR crystal)

### Duration

Scan number: 16

Resolution: 4.00 cm⁻¹

Advanced: CO₂/H₂O correction is conducted.

### Method for Calculating P1

(1) The Ge ATR crystal (refractive index=4.0) is set to the spectrophotometer.
(2) “Scan Type” is set to “Background”, and “Units” are set to “EGY”. The background is measured under these conditions.

### (3) “Scan Type” is set to “Sample”, and “Units” are set to

(4) 0.01 g of a toner is accurately weighed and placed on the ATR crystal.
(5) A pressure is applied to the sample with a pressure arm. (“Force Gauge” is set to 90.)
(6) Measurement of the sample is performed.
(7) The obtained FT-IR spectrum is subjected to base line correction in “Automatic Correction”.
(8) The maximum of the absorption peak intensity in the range of 2,843 cm⁻¹ or more and 2,853 cm⁻¹ or less is calculated (Pa1).
(9) The average of the absorption intensity at 3,050 cm⁻¹ and the absorption intensity at 2,600 cm⁻¹ is calculated (Pa2).
(10) The value calculated by subtracting Pa2 from Pa1 is defined as Pa (Pa1−Pa2=Pa). This value Pa is defined as a maximum absorption peak intensity in the range of 2,843 cm⁻¹ or more and 2,853 cm⁻¹ or less.
(11) The maximum of the absorption peak intensity in the range of 1,713 cm⁻¹ or more and 1,723 cm⁻¹ or less is calculated (PM).
(12) The average of the absorption intensity at 1,763 cm⁻¹ and the absorption intensity at 1,630 cm⁻¹ is calculated (Pb2).
(13) The value calculated by subtracting Pb2 from Pb1 is defined as Pb (Pb1−Pb2=Pb). This value Pb is defined as a maximum absorption peak intensity in the range of 1,713 cm⁻¹ or more and 1,723 cm⁻¹ or less.
(14) The value calculated by divining Pa by Pb is defined as P1 (Pa/Pb=P1).

### Method for Calculating P2

(1) The KRS5 ATR crystal (refractive index=2.4) is set to the spectrophotometer.
(2) 0.01 g of a toner is accurately weighed and placed on the ATR crystal.
(3) A pressure is applied to the sample with a pressure arm. (“Force Gauge” is set to 90.)
(4) Measurement of the sample is performed.
(5) The obtained FT-IR spectrum is subjected to base line correction in “Automatic Correction”.
(6) The maximum of the absorption peak intensity in the range of 2,843 cm⁻¹ or more and 2,853 cm⁻¹ or less is calculated (Pc1).
(7) The average of the absorption intensity at 3,050 cm⁻¹ and the absorption intensity at 2,600 cm⁻¹ is calculated (Pc2).
(8) The value calculated by subtracting Pc2 from Pc1 is defined as Pc (Pc1−Pc2=Pc). This value Pc is defined as a maximum absorption peak intensity in the range of 2,843 cm⁻¹ or more and 2,853 cm⁻¹ or less.
(9) The maximum of the absorption peak intensity in the range of 1,713 cm⁻¹ or more and 1,723 cm⁻¹ or less is calculated (Pd1).
(10) The average of the absorption intensity at 1,763 cm⁻¹ and the absorption intensity at 1,630 cm⁻¹ is calculated (Pd2).
(11) The value calculated by subtracting Pd2 from Pd1 is defined as Pd (Pd1−Pd2=Pd). This value Pd is defined as a maximum absorption peak intensity in the range of 1,713 cm⁻¹ or more and 1,723 cm⁻¹ or less.
(12) The value calculated by divining Pc by Pd is defined as P2 (Pc/Pd=P2).

### Method for Calculating P1/P2

The ratio P1/P2 is calculated using P1 and P2 determined as described above.

### Method for Measuring Weight-Average Molecular Weight (Mw) and Peak Molecular Weight (Mp) of Resin

The weight-average molecular weight (Mw) and the peak molecular weight (Mp) of resins are measured by gel permeation chromatography (GPC) as follows.

First, a sample (resin) is dissolved in tetrahydrofuran (THF) at room temperature over a period of 24 hours. The resulting solution is then filtered with a solvent-resistant membrane filter MAISHORI Disk (produced by Tosoh Corporation) having a pore diameter of 0.2 μm to prepare a sample solution. The sample solution is adjusted so that the concentration of a component soluble in THF becomes about 0.8% by mass. The measurement is conducted using this sample solution under the following conditions:

Apparatus: HLC8120 GPC (detector: RI) (produced by Tosoh Corporation)
Column: Combination of seven columns, Shodex KF-801, 802, 803, 804, 805, 806, and 807 (produced by SHOWA DENKO K.K.)

### Eluent: THF

Flow rate: 1.0 mL/min.
Oven temperature: 40.0° C.
Amount of sample injection: 0.10 mL

In calculation of the molecular weight of the sample, a molecular-weight calibration curve prepared by using standard polystyrene resins (for example, trade name TSK Standard Polystyrene F-850, F-450, F-288, F-128, F-80, F-40, F-20, F-10, F-4, F-2, F-1, A-5000, A-2500, A-1000, and A-500, produced by Tosoh Corporation) is used.

### Measurement of Maximum Endothermic Peak of Wax

The maximum endothermic peak of a wax is measured in accordance with ASTM D3418-82 with a differential scanning calorimeter Q1000 (produced by TA Instruments). Temperature correction of a detection portion of the apparatus is performed using melting points of indium and zinc, and correction of the quantity of heat is performed using the heat of fusion of indium.

The maximum endothermic peak of a wax is specifically measured as follows.

About 5 mg of a wax is accurately weighed and is placed in an aluminum pan. An empty aluminum pan is used as a reference. The measurement is conducted in the measurement temperature range of 30° C. to 200° C. and at a temperature-increasing rate of 10° C./min. In the measurement, the temperature is once increased to 200° C., and is then decreased to 30° C. Subsequently, the temperature is increased again. A maximum endothermic peak of a DSC curve in the temperature range of 30° C. to 200° C. in this second temperature increasing process is defined as the maximum endothermic peak of the endothermic curve in the DSC measurement of the wax.

### Method for Measuring Weight-Average Particle Diameter (D4) and Number-Average Particle Diameter (D1)

The weight-average particle diameter (D4) and the number-average particle diameter (D1) of a toner are calculated as described below. A precise particle size distribution analyzer Coulter Counter Multisizer 3 (registered trademark, produced by Beckman Coulter, Inc.) equipped with a 100-μm aperture tube and using a pore electrical resistance method is used as a measuring apparatus. Attached dedicated software Beckman Coulter Multisizer 3 Version 3.51 (produced by Beckman Coulter, Inc.) is used for setting the measurement conditions and analyzing the measurement data. The measurement is performed with the number of effective measurement channels being 25,000.

As for an aqueous electrolyte solution used for the measurement, it is possible to use a solution prepared by dissolving analytical grade sodium chloride in ion-exchange water so as to have a concentration of about 1% by mass, for example, ISOTON II (produced by Beckman Coulter, Inc.).

Prior to the measurement and the analysis, the dedicated software is set as follows.

On the screen of “modification of the standard operating method (SOM)” of the dedicated software, the total count number in the control mode is set to 50,000 particles, the number of measurements is set to one time, and the Kd value is set to a value obtained by using “Standard particles 10.0 μm” (produced by Beckman Coulter, Inc.). The threshold value and the noise level are automatically set by pressing the “threshold value/noise level measurement button”. In addition, the current is set to 1,600 μA, the gain is set to 2, the electrolyte solution is set to ISOTON II, and a check mark is entered in the “aperture tube flush performed after measurement”.

On the screen of “setting of conversion from pulses to particle diameter” of the dedicated software, the bin interval is set to the logarithmic particle diameter, the particle diameter bin is set to 256 particle diameter bins, and the particle diameter range is set to a range from 2 μm to 60 μm.

The specific measurement method will now be described.

(1) About 200 mL of the above aqueous electrolyte solution is put in a 250-mL round-bottom glass beaker dedicated to Multisizer 3, and the beaker is set in a sample stand. Stirring is performed in the counterclockwise direction with a stirrer rod at a speed of 24 rotations/sec. Contamination and air bubbles in an aperture tube are removed by the function of “aperture flush” of the dedicated software.
(2) About 30 mL of the aqueous electrolyte solution is put in a 100-mL flat-bottom glass beaker. As a dispersing agent, about 0.3 mL of a diluted solution prepared by diluting Contaminon N (a 10% by mass aqueous solution of a neutral detergent for washing a precision measuring device, containing a nonionic surfactant, an anionic surfactant, and an organic builder, having a pH of 7, and produced by Wako Pure Chemical Industries, Ltd.) with ion-exchange water by a factor of about three on a mass basis is added to the aqueous electrolyte solution.
(3) An ultrasonic dispersing device Ultrasonic Dispersion System Tetora 150 (produced by Nikkaki Bios Co., Ltd.) having an electrical output of 120 W and including two oscillators that have an oscillation frequency of 50 kHz and that are arranged such that the phase is shifted by 180 degrees is prepared. About 3.3 L of ion-exchange water is put in a water tank of the ultrasonic dispersing device, and about 2 mL of Contaminon N is added to the water tank.
(4) The beaker in (2) above is set in a beaker fixing hole of the ultrasonic dispersing device, and the ultrasonic dispersing device is operated. The height position of the beaker is adjusted such that the resonance state of the liquid surface of the aqueous electrolyte solution in the beaker becomes the maximum.
(5) About 10 mg of a toner is added to the aqueous electrolyte solution little by little and is dispersed while ultrasonic waves are applied to the aqueous electrolyte solution in the beaker in (4). Subsequently, an ultrasonic dispersion treatment is further continued for 60 seconds. During the ultrasonic dispersion, the water temperature of the water tank is appropriately adjusted to 10° C. or higher and 40° C. or lower.
(6) The aqueous electrolyte solution of (5), in which the toner is dispersed, is added dropwise to the round-bottom beaker of (1) set in the sample stand using a pipette so that the measurement concentration is adjusted to about 5%. The measurement is then performed until the number of measured particles reaches 50,000.
(7) The measurement data is analyzed by the dedicated software attached to the apparatus to calculate the weight-average particle diameter (D4) and the number-average particle diameter (D1). In this analysis, when “graph/% by volume” is set in the dedicated software, the “average diameter” on the screen of the “analysis/volume statistical value (arithmetic average)” is the weight-average particle diameter (D4). When “graph/% by number” is set in the dedicated software, the “average diameter” on the screen of the “analysis/number statistical value (arithmetic average)” is the number-average particle diameter (D1).

### Method for Calculating Amount of Fine Particles (Particles of 4.0 μm or Less)

The amount (% by number) of fine particles (particles having a diameter of 4.0 μm or less) on a number basis in a toner is calculated by performing the measurement with Multisizer 3 described above and then analyzing the data.

The percentage of particles having a diameter of 4.0 μm or less on a number basis in the toner is calculated by the following procedure. First, in the dedicated software, “graph/% by number” is set so that the chart of the measurement results is expressed in units of percent by number. Next, a check mark is entered in “<” of a particle diameter setting portion on the screen of “format/particle diameter/statistics on particle diameter”, and “4” is entered in the particle diameter input portion displayed under the particle diameter setting portion. The numerical value in the “<4 μm” display portion on the screen of “analysis/number statistical value (arithmetic average)” is the percentage of particles having a diameter of 4.0 μm or less on a number basis in the toner.

### Method for Calculating Amount of Coarse Particles (Particles of 10.0 μm or More)

The amount (% by volume) of coarse particles (particles having a diameter of 10.0 μm or more) on a volume basis in a toner is calculated by performing the measurement with Multisizer 3 described above and then analyzing the data. The percentage of particles having a diameter of 10.0 μm or more on a volume basis in the toner is calculated by the following procedure. First, in the dedicated software, “graph/% by volume” is set so that the chart of the measurement results is expressed in units of percent by volume. Next, a check mark is entered in “>” of the particle diameter setting portion on the screen of “format/particle diameter/statistics on particle diameter”, and “10” is entered in the particle diameter input portion displayed under the particle diameter setting portion. The numerical value in the “>10 μm” display portion on the screen of “analysis/volume statistical value (arithmetic average)” is the percentage of particles having a diameter of 10.0 μm or more on a volume basis in the toner.

### Method for Measuring Intensity of Magnetization of Magnetic Carrier and Magnetic Carrier Core Material

The intensity of magnetization of a magnetic carrier and a magnetic carrier core material can be determined with a vibrating magnetic field-type magnetic characteristic measuring apparatus (vibrating sample magnetometer) or a direct current magnetization characteristics recording apparatus (B-H tracer). In Examples of the present application, the measurement is conducted by the following procedure using a vibrating magnetic field-type magnetic characteristic measuring apparatus BHV-30 (produced by Riken Denshi Co., Ltd.).

(1) A cylindrical plastic container sufficiently densely filled with a carrier is used as a sample. The actual mass of the carrier filling the container is measured. Subsequently, the magnetic carrier particles in the plastic container are bonded with an instant adhesive so that the magnetic carrier particles do not move.
(2) The external magnetic field axis and the magnetizing moment axis at 5,000/4π (kA/m) are calibrated using a standard sample.
(3) The intensity of magnetization is measured from a loop of the magnetizing moment obtained when a sweep rate is set to 5 min/loop and an external magnetic field of 1,000/4π (kA/m) is applied. On the basis of these results, the intensity of magnetization is divided by the sample mass to determine the intensity of magnetization (Am²/kg) of the carrier.

### Method for Measuring Volume-Distribution-Based 50% Particle Diameter (D50) of Magnetic Carrier

The particle size distribution is measured with a laser diffraction/scattering particle size distribution analyzer Microtrac MT3300EX (produced by NIKKISO CO., LTD.). A sample feeding device for dry measurement, i.e., one-shot dry-type sample conditioner Turbotrac (produced by NIKKISO CO., LTD.) is attached to perform the measurement. Regarding the supply conditions of Turbotrac, a dust collector is used as a vacuum source, the air flow rate is set to about 33 L/sec, and the pressure is set to about 17 kPa. The control is automatically performed by software. The 50% particle diameter (D50), which is a cumulative value on a volume basis, is determined as the particle diameter. The control and the analysis are performed using the attached software (Version 10.3.3-202D).

The measurement conditions are as follows:

Set Zero time: 10 seconds
Measurement time: 10 seconds
Number of measurements: once
Particle refractive index: 1.81
Particle shape: non-spherical shape
Upper limit of measurement: 1,408 μm
Lower limit of measurement: 0.243 μm
Measurement environment: room temperature and normal humidity environment (23° C. 50% RH)

### Method for Measuring True Specific Gravity of Magnetic Carrier

The true specific gravity of the magnetic carrier is measured with a dry automatic densimeter Accupyc 1330 (produced by Shimadzu Corporation). First, 5 g of a sample that has been left to stand for 24 hours in the environment of 23° C./50% RH is accurately weighed and put in a measurement cell (10 cm³). The measurement cell is set in a sample chamber of a main body of the measurement device. The measurement can be automatically performed by inputting the sample weight to the main body and starting the measurement. Regarding the condition for the automatic measurement, helium gas adjusted at 20.000 psig (2.392×10² kPa) is used. The state in which, after the sample chamber is purged with the helium gas 10 times, a change in the pressure in the sample chamber becomes 0.005 psig/min (3.447×10⁻² kPa/min) is assumed to be an equilibrium state, and the sample chamber is repeatedly purged with the helium gas until the change in the pressure in the sample chamber reaches the equilibrium state. The pressure in the sample chamber of the main body at the time of the equilibrium state is measured. The sample volume can be calculated from the change in the pressure at the time of reaching the equilibrium state.

Since the sample volume can be calculated, the true specific gravity of the sample can be calculated by the following formula:

True specific gravity of sample (g/cm³)=sample weight (g)/sample volume (cm³)

The average of the values obtained by repeating this automatic measurement five times is assumed to be the true specific gravity (g/cm³) of the magnetic carrier and the magnetic core.

### Measurement of Elastic Deformation Rate of Outermost Surface Layer of Electrophotographic Photosensitive Member

The elastic deformation rate (%) is measured with a microhardness measuring device Fischer Scope H100V (produced by Fischer Instruments K.K.). Specifically, a load of up to 6 mN is continuously applied to a Vickers pyramid diamond indenter that has an angle between the opposite faces of 136° and that is arranged on the surface of the outermost surface layer of an electrophotographic photosensitive member in an environment at a temperature of 25° C. and a humidity of 50% RH, and the indentation depth under the load is directly read. The measurement is conducted stepwise (at 273 points with a holding time of 0.1 s for each point) from an initial load of 0 mN to a final load of 6 mN.

The elastic deformation rate can be determined on the basis of a workload (energy) applied by the indenter to the surface of the outermost surface layer of the electrophotographic photosensitive member when the indenter is pressed in the surface of the outermost surface layer of the electrophotographic photosensitive member, i.e., the change in energy due to an increase and a decrease in the load of the indenter applied to the surface of the outermost surface layer of the electrophotographic photosensitive member. Specifically, the elastic deformation rate can be determined by the following formula:

Elastic deformation rate (%)=(We/Wt)×100.

In the above formula, “Wt (nJ)” represents total quantity of work, and “We (nJ)” represents the quantity of work done by the elastic deformation (nJ).

### EXAMPLES

### Production Example of Polyester Resin A

Polyoxypropylene(2.2)-2,2-bis(4-hydroxyphenyl)propane: 55.1 parts by mass

Polyoxyethylene(2.2)-2,2-bis(4-hydroxyphenyl)propane: 19.3 parts by mass

Terephthalic acid: 8.0 parts by mass

Trimellitic anhydride: 6.9 parts by mass

Fumaric acid: 10.5 parts by mass

Titanium tetrabutoxide: 0.2 parts by mass

The above materials were charged in a 4-L four-neck glass flask. A thermometer, a stirring rod, a condenser, and a nitrogen-introducing tube were attached to the four-necked flask, and the flask was placed in a mantle heater. Next, the inside of the four-necked flask was substituted with nitrogen gas and the temperature was then gradually increased while stirring. The resulting reaction mixture was allowed to react for four hours while stirring was performed at 180° C. Thus, a polyester resin A was obtained. Regarding the molecular weights measured by GPC, the polyester resin A had a weight-average molecular weight (Mw) of 5,000 and a peak molecular weight (Mp) of 3,000. The polyester resin A had a softening point of 85° C.

### Production Example of Polyester Resin B

Polyoxypropylene(2.2)-2,2-bis(4-hydroxyphenyl)propane: 40.0 parts by mass

Terephthalic acid: 55.0 parts by mass

Adipic acid: 1.0 part by mass

Titanium tetrabutoxide: 0.6 parts by mass

The above materials were charged in a 4-L four-neck glass flask. A thermometer, a stirring rod, a condenser, and a nitrogen-introducing tube were attached to the four-necked flask, and the flask was placed in a mantle heater. Next, the inside of the four-necked flask was substituted with nitrogen gas and the temperature was then gradually increased to 220° C. while stirring. The resulting reaction mixture was allowed to react for eight hours. Subsequently, 4.0 parts by mass (0.021 mol) of trimellitic anhydride was added thereto, and the resulting reaction mixture was allowed to react at 180° C. for four hours. Thus, a polyester resin B was obtained. Regarding the molecular weights measured by GPC, the polyester resin B had a weight-average molecular weight (Mw) of 300,000 and a peak molecular weight (Mp) of 10,000. The polyester resin B had a softening point of 135° C.

### Toner Production Example 1

Polyester resin A: 60 parts by mass

Polyester resin B: 40 parts by mass

Fischer-Tropsch wax (peak temperature of maximum endothermic peak: 78° C.): 5 parts by mass

Aluminum 3,5-di-tert-butyl salicylate: 0.5 parts by mass

C.I. Pigment Blue 15:3: 5.0 parts by mass

Hydrophobic silica fine particle 1 (surface-treated with 10% by mass of hexamethyldisilazane, number-average particle diameter: 90 nm): 2.0 parts by mass

The above materials were mixed in a Henschel mixer (Model FM-75, produced by Mitsui Miike Kakoki K.K.) and were then kneaded with a twin-screw kneader (Model PCM-30, produced by Ikegai Corp.) set at a temperature of 120° C. The resulting kneaded product was cooled and coarsely ground to 1 mm or less with a hammer mill, thus obtaining a coarsely ground product. The coarsely ground product was pulverized with a mechanical pulverizer (T-250, produced by FREUND-TURBO CORPORATION) to obtain a finely pulverized product. The finely pulverized product was classified with a multi-division classifier utilizing the Coanda effect, thus obtaining toner particles 1.

Next, 3.0 parts by mass of hydrophobic silica fine particles 1 were added to 100 parts by mass of the toner particles 1, and the resulting mixture was mixed using a Henschel Mixer (Model FM-75, produced by Mitsui Miike Kakoki K.K.). Thus, fine particle-added toner particles 1 were obtained.

The fine particle-added toner particles 1 were subjected to a surface treatment with the heat treatment apparatus illustrated in FIG. 1 to obtain surface-treated toner particles 1.

The inner diameter of the apparatus was 450 mm. Regarding an outlet portion of the hot-air supply unit, the inner diameter was 200 mm and the outer diameter was 300 mm. Hot air was introduced through rectifying blades (angle: 50°, blade thickness: 1 mm, the number of blades: 36). A ridge angle of the first nozzle of the raw material supply unit was 40°, and a ridge angle of the second nozzle was 60°. A second nozzle having a turn-up portion on the lower end thereof was used. The angle formed by ridge lines of the turn-up portion was 140° and the outer diameter of the second nozzle was 150 mm. The hot-air supply unit and the first nozzle of the heat treatment apparatus used in this Example are integrated with each other, have a heat-insulating structure, and are covered with a jacket.

The operating conditions were set to as follows: The amount of feed (F) was 15 kg/hr, the hot air temperature (T1) was 160° C., the amount of flow of hot air (Q1) was 12.0 m³/min, the total amount of cold air 1 (Q2) was 4.0 m³/min, the total amount of cold air 2 (Q3) was 2.0 m³/min, the amount of flow of compressed gas (IJ) was 1.6 m³/min, and the amount of air flow of blower (Q4) was 22.0 m³/min.

The resulting surface-treated toner particles 1 were classified again with the multi-division classifier utilizing the Coanda effect. Thus, classified surface-treated toner particles 1 having desired particle diameters were obtained.

Next, 1.0 part by mass of titanium oxide fine particles (surface-treated with 16% by mass of isobutyltrimethoxysilane, number-average particle diameter: 10 nm) and 0.8 parts by mass of hydrophobic silica fine particles (surface-treated with 10% by mass of hexamethyldisilazane, number-average particle diameter: 20 nm) were added to 100 parts by mass of the classified surface-treated toner particles 1. The resulting mixture was mixed using a Henschel Mixer (Model FM-75, produced by Mitsui Miike Kakoki K.K.) to obtain a toner 1. Properties of the toner 1 are shown in Table 2.

### Toner Production Examples 2 to 13 and Toner Production Examples 16 to 20

Toners 2 to 13 and toners 16 to 20 were obtained as in Toner production example 1 except that the toner formulation and the conditions of the heat treatment apparatus in Toner production example 1 were changed as shown in Table 1. Properties of the toners 2 to 13 and the toners 16 to 20 are shown in Table 2.

### Toner Production Examples 14 and 15

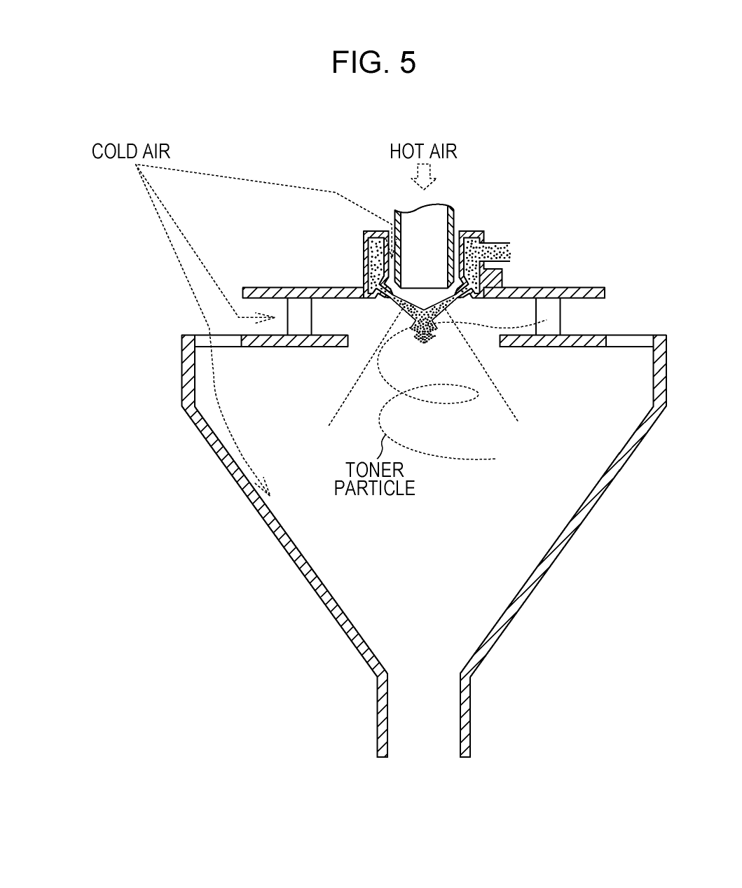

In Toner production example 1, the toner formulation was changed as shown in Table 1. Furthermore, in the heat treatment of fine particle-added toner particles, a heat treatment apparatus illustrated in FIG. 5 was used. In the heat treatment apparatus illustrated in FIG. 1, hot air is introduced from a direction substantially horizontal to the apparatus, whereas in the heat treatment apparatus illustrated in FIG. 5, hot air is introduced from a substantially vertical direction. In addition, the heat treatment apparatus illustrated in FIG. 5 does not include a pole in an axial central portion of the apparatus. Therefore, in the heat treatment apparatus illustrated in FIG. 5, the time during which toner particles pass through a heat treatment space is short and the application of heat also tends to be uneven, as compared with the case where the heat treatment apparatus illustrated in FIG. 1 is used.

Properties of the toners 14 and 15 are shown in Table 2.

TABLE 1

| | Fine particle contained in | | | | | | |
|---|---|---|---|---|---|---|---|
| | toner particle in advance | | Fine particle added before heat treatment | | | Heat treatment condition | |
| | | Amount | | Amount | | | Amount of |
| | | added | | added | | Hot air | flow |
| | | (parts | | (parts by | Heat treatment | temperature | of hot air |
| Toner | Type | by mass) | Type | mass) | apparatus used | (° C.) | (m³/min) |
| Toner 1 | Hydrophobic silica fine particle 1 | 2.0 | Hydrophobic silica fine particle 1 | 3.0 | FIG. 1 | 160 | 12 |
| Toner 2 | Hydrophobic silica fine particle 1 | 2.0 | Hydrophobic silica fine particle 1 | 1.5 | FIG. 1 | 160 | 12 |
| Toner 3 | Hydrophobic silica fine particle 1 | 2.0 | Hydrophobic silica fine particle 1 | 3.0 | FIG. 1 | 170 | 12 |
| Toner 4 | Hydrophobic silica fine particle 1 | 2.0 | Hydrophobic silica fine particle 1 | 1.0 | FIG. 1 | 160 | 12 |
| Toner 5 | Hydrophobic silica fine particle 1 | 2.0 | Hydrophobic silica fine particle 1 | 1.0 | FIG. 1 | 170 | 12 |
| Toner 6 | Hydrophobic silica fine particle 1 | 2.0 | Hydrophobic silica fine particle 1 | 1.0 | FIG. 1 | 150 | 12 |
| Toner 7 | Hydrophobic silica fine particle 1 | 0.5 | Hydrophobic silica fine particle 1 | 2.0 | FIG. 1 | 160 | 12 |
| Toner 8 | Hydrophobic silica fine particle 1 | 0.5 | Hydrophobic silica fine particle 1 | 2.0 | FIG. 1 | 170 | 12 |
| Toner 9 | Hydrophobic silica fine particle 1 | 0.5 | Hydrophobic silica fine particle 1 | 2.0 | FIG. 1 | 180 | 12 |
| Toner 10 | — | — | Hydrophobic silica fine particle 1 | 1.0 | FIG. 1 | 180 | 12 |
| Toner 11 | Hydrophobic silica fine particle 1 | 2.0 | — | — | FIG. 1 | 150 | 12 |
| Toner 12 | Hydrophobic silica fine particle 1 | 2.0 | — | — | FIG. 1 | 170 | 12 |
| Toner 13 | Hydrophobic silica fine particle 1 | 0.5 | — | — | FIG. 1 | 180 | 12 |
| Toner 14 | — | — | Hydrophobic silica fine particle 1 | 0.5 | FIG. 5 | 280 | 5 |
| Toner 15 | — | — | Hydrophobic silica fine particle 1 | 0.5 | FIG. 5 | 240 | 5 |
| Toner 16 | — | — | — | — | FIG. 1 | 180 | 12 |
| Toner 17 | — | — | Hydrophobic silica fine particle 1 | 0.5 | FIG. 1 | 220 | 12 |
| Toner 18 | — | — | Hydrophobic silica fine particle 1 | 0.5 | FIG. 1 | 150 | 12 |
| Toner 19 | Hydrophobic silica fine particle 1 | 2.0 | Hydrophobic silica fine particle 1 | 3.0 | FIG. 1 | 130 | 12 |
| Toner 20 | — | — | — | — | — | — | — |

TABLE 2

| | | | | FPIA-3000 | | | |
|---|---|---|---|---|---|---|---|
| | | | | | Particles | Particles of | |
| | | | | | having | 0.50 μm or | |
| | Coulter Counter Multisizer III | | | | circularity of | more and less | |
| | | Particles of 4 μm | Particles of 10 μm | | 0.990 or more | than 1.98 μm | |
| | D4 | or less | or more | Average | (% by | (% by | ATR-IR |
| Toner | (μm) | (% by number) | (% by volume) | circularity | number) | number) | P1/P2 |
| Toner 1 | 6.1 | 23.9 | 0.7 | 0.967 | 10.4 | 3 | 1.54 |
| Toner 2 | 6.1 | 24.5 | 0.6 | 0.965 | 10.1 | 7 | 1.55 |
| Toner 3 | 6.1 | 24.6 | 0.6 | 0.972 | 12.7 | 1 | 1.68 |
| Toner 4 | 6.1 | 24.8 | 0.7 | 0.964 | 15.3 | 8 | 1.55 |
| Toner 5 | 6.0 | 25.1 | 0.4 | 0.969 | 18.4 | 6 | 1.65 |
| Toner 6 | 6.1 | 24.9 | 0.5 | 0.962 | 10.3 | 9 | 1.42 |
| Toner 7 | 6.0 | 25.6 | 0.4 | 0.966 | 13.1 | 5 | 1.71 |
| Toner 8 | 6.1 | 25.1 | 0.5 | 0.97 | 18.2 | 4 | 1.84 |
| Toner 9 | 6.0 | 25.4 | 0.4 | 0.974 | 22.3 | 3 | 1.91 |
| Toner 10 | 6.1 | 25.1 | 0.8 | 0.974 | 24.2 | 5 | 1.98 |
| Toner 11 | 6.1 | 24.1 | 0.3 | 0.961 | 15.8 | 9 | 1.56 |
| Toner 12 | 6.0 | 23.9 | 0.2 | 0.965 | 19.8 | 9 | 1.73 |
| Toner 13 | 6.0 | 23.7 | 0.8 | 0.969 | 24.2 | 7 | 1.92 |
| Toner 14 | 6.0 | 25.8 | 0.6 | 0.967 | 27.7 | 20 | 2.55 |
| Toner 15 | 6.2 | 23.9 | 0.6 | 0.958 | 22.6 | 24 | 2.08 |
| Toner 16 | 6.1 | 25.4 | 0.7 | 0.968 | 24.2 | 7 | 2.06 |
| Toner 17 | 6.1 | 25.6 | 0.7 | 0.986 | 27.8 | 3 | 2.27 |
| Toner 18 | 6.0 | 24.8 | 0.6 | 0.962 | 12.9 | 11 | 2.05 |
| Toner 19 | 5.9 | 24.1 | 0.6 | 0.958 | 6.2 | 16 | 1.18 |
| Toner 20 | 5.9 | 23.8 | 0.5 | 0.945 | 1.1 | 28 | 0.98 |

### Magnetic Carrier Production Example 1

### Weighing and Mixing Step

Ferrite raw materials were weighed as described below.

Fe₂O₃: 59.8% by mass

MnCO₃ 34.7% by mass

Mg(OH)₂: 4.6% by mass

SrCO₃: 0.9% by mass

Subsequently, these materials were ground and mixed in a dry ball mill using zirconia balls (diameter: 10 mm) for two hours.

### Calcination Step

After the grinding and mixing, the resulting mixture was calcined in a burner firing furnace at 960° C. for two hours in air to prepare calcined ferrite.

### Grinding Step

The calcined ferrite was ground to about 0.5 mm using a crusher. Subsequently, 35 parts by mass of water was added to 100 parts by mass of the calcined ferrite, and the resulting mixture was ground in a wet bead mill for five hours using zirconia beads (diameter: 1.0 mm). Thus, a ferrite slurry was obtained.

### Granulation Step

To the ferrite slurry, 1.5 parts by mass of polyvinyl alcohol was added as a binder relative to 100 parts by mass of the calcined ferrite. The resulting mixture was granulated into spherical particles with a spray dryer (produced by Ohkawara Kakohki Co., Ltd.).

### Firing Step

Firing was conducted at 1,050° C. for four hours in an electric furnace in a nitrogen atmosphere (oxygen concentration: 0.02% by volume) while controlling the firing atmosphere.

### Screening Step

Aggregated particles were disintegrated, and coarse particles were then removed by screening the disintegrated particles with a sieve having an opening of 250 μm to obtain core particles 1.

Coating Step

Silicone varnish: 75.8 parts by mass (SR2410 produced by Dow Corning Toray Co., Ltd., solid content: 20% by mass)

γ-Aminopropyltriethoxysilane: 1.5 parts by mass

Toluene: 22.7 parts by mass

The above materials were mixed to prepare a resin solution A. Next, 100 parts by mass of the core particles 1 were put in a universal mixer (produced by DALTON CORPORATION), and heated to a temperature of 50° C. under reduced pressure. The resin solution A was added dropwise to the core particles 1 over a period of two hours in an amount corresponding to 15 parts by mass in terms of filling resin component relative to 100 parts by mass of the core particles 1. Furthermore, the resulting mixture was stirred at 50° C. for one hour. Subsequently, the temperature was increased to 80° C. to remove the solvent. The resulting sample was transferred to Julia Mixer (produced by TOKUJU CORPORATION), and heat-treated in a nitrogen atmosphere at 180° C. for two hours. The sample was then classified through a mesh with an opening of 70 μm to prepare magnetic core particles 1.

Next, 100 parts by mass of the magnetic core particles 1 were put in a Nauta Mixer (produced by Hosokawa Micron Corporation), and adjusted to 70° C. under reduced pressure while stirring was performed under the conditions of a screw rotation speed of 100 min⁻¹ and a rotation speed of 3.5 min⁻¹. The resin solution A was diluted with toluene so that the solid content thereof became 10% by mass. The resin solution was then put therein so that the amount of coating resin component became 0.5 parts by mass relative to 100 parts by mass of the magnetic core particles 1. The removal of the solvent and a coating operation were performed over a period of two hours. The temperature was then increased to 180° C. and the stirring was continued for two hours. Subsequently, the temperature was decreased to 70° C. The sample was transferred to a universal mixer (produced by DALTON CORPORATION). The resin solution A was put therein so that the amount of coating resin component became 0.5 parts by mass relative to 100 parts by mass of the magnetic core particles 1 serving as a raw material. The removal of the solvent and a coating operation were performed over a period of two hours. The resulting sample was transferred to Julia Mixer (TOKUJU CORPORATION) and heat-treated in a nitrogen atmosphere at 180° C. for four hours. The sample was then classified through a mesh with an opening of 70 μm to obtain a magnetic carrier 1. The magnetic carrier 1 had a D50 of 43.1 μm and a true specific gravity of 3.9 g/cm³. The amount of magnetization of the magnetic carrier 1 under 1,000 oersted was 52.7 Am²/kg.

### Magnetic Carrier Production Example 2

A magnetic carrier 2 was obtained as in Magnetic carrier production example 1 except that, in the firing step of Magnetic carrier production example 1, the oxygen concentration was changed to 0.3% by volume and the firing temperature was changed to 1,150° C. The magnetic carrier 2 had a D50 of 45.0 μm and a true specific gravity of 4.8 g/cm³. The amount of magnetization of the magnetic carrier 2 under 1,000 oersted was 53.8 Am²/kg.

### Magnetic Carrier Production Example 3

Fe₂O₃: 62.8% by mass

MnCO₃: 7.7% by mass

Mg(OH)₂: 15.6% by mass

SrCO₃: 13.9% by mass

A magnetic carrier 3 was obtained as in Magnetic carrier production example 1 except that, in the weighing and mixing step of Magnetic carrier production example 1, the raw materials were changed to the above raw materials and, in the firing step, firing was conducted in air at 1,300° C. for four hours. The magnetic carrier 3 had a D50 of 40.4 μm and a true specific gravity of 3.6 g/cm³. The amount of magnetization of the magnetic carrier 3 under 1,000 oersted was 52.1 Am²/kg.

### Electrophotographic Photosensitive Member Production Example 1

An electrophotographic photosensitive member 1 was produced as described below. First, an aluminum cylinder (composed of an aluminum alloy specified in JIS A3003) having a length of 370 mm, an outer diameter of 32 mm, and a wall thickness of 3 mm was prepared by cutting. A surface roughness of this cylinder measured in the direction of the rotation axis was Rzjis=0.08 μm. The cylinder was subjected to ultrasonic cleaning in pure water containing a detergent (trade name: Chemicohl CT, produced by TOKIWA CHEMICAL INDUSTRIES CO., LTD.). Subsequently, the detergent was rinsed away, and ultrasonic cleaning was further conducted in pure water to perform a degreasing treatment.

A slurry containing 60 parts by mass of a titanium oxide powder having a coating film composed of tin oxide doped with antimony (trade name: KRONOS ECT-62, produced by Titan Kogyo Ltd.), 60 parts by mass of a titanium oxide powder (trade name: Titone SR-1T, produced by Sakai Chemical Industry Co., Ltd.), 70 parts by mass of resol-type phenolic resin (trade name: PHENOLITE J-325, produced by DIC Corporation, solid content: 70%), 50 parts by mass of 2-methoxy-1-propanol, and 50 parts by mass of methanol was dispersed for about 20 hours in a ball mill to obtain a dispersion liquid. The average particle diameter of fillers contained in this dispersion liquid was 0.25 μm.

The dispersion liquid prepared as described above was applied onto the aluminum cylinder by a dipping method. The aluminum cylinder coated with the dispersion liquid was heated and dried for 48 minutes in a hot-air dryer adjusted at a temperature of 150° C. to cure the coating film of the dispersion liquid. Thus, an electrically conductive layer having a thickness of 15 μm was formed.

Next, 10 parts by mass of a copolymerization nylon resin (trade name: AMILAN CM8000, produced by Toray Industries, Inc.) and 30 parts by mass of a methoxymethylated nylon resin (trade name: TORESIN EF30T, produced by Nagase ChemteX Corporation) were dissolved in a mixed liquid of 500 parts by mass of methanol and 250 parts by mass of butanol to prepare a solution. This solution was applied onto the electrically conductive layer by dipping. The aluminum cylinder coated with the solution was placed in a hot-air dryer adjusted at a temperature of 100° C. for 22 minutes to cure the coating film of the solution by heating and drying. Thus, an underlying layer having a thickness of 0.45 μm was formed.

Next, a mixed solution containing 4 parts by mass of a hydroxygallium phthalocyanine pigment having strong peaks at Bragg angle 2θ±0.2° of 7.4° and 28.2° in a CuKα ray diffraction spectrum, 2 parts by mass of a polyvinyl butyral resin (trade name: S-LEC BX-1, produced by Sekisui Chemical Co., Ltd.), and 90 parts by mass of cyclohexanone was dispersed for ten hours in a sand mill using glass beads having a diameter of 1 mm. Subsequently, 110 parts by mass of ethyl acetate was added to the resulting mixed solution to prepare a coating solution for a charge generation layer. This coating solution was applied onto the underlying layer by dipping. The aluminum cylinder coated with the coating solution was placed in a hot-air dryer adjusted at a temperature of 80° C. for 22 minutes to cure the coating film of the coating solution by heating and drying. Thus, a charge generation layer having a thickness of 0.17 μm was formed.

Next, 35 parts by mass of a triarylamine compound represented by structural formula (11) below and 50 parts by mass of a bisphenol Z polycarbonate resin (trade name: Iupilon 2400, produced by Mitsubishi Engineering-Plastics Corporation) were dissolved in 320 parts by mass of monochlorobenzene and 50 parts by mass of dimethoxymethane to prepare a coating solution for a first charge transport layer. This coating solution was applied onto the charge generation layer by dipping. The aluminum cylinder coated with the coating solution was heated and dried in a hot-air dryer adjusted at a temperature of 100° C. for 40 minutes to cure the coating film of the coating solution. Thus, a first charge transport layer having a thickness of 20 μm was formed.

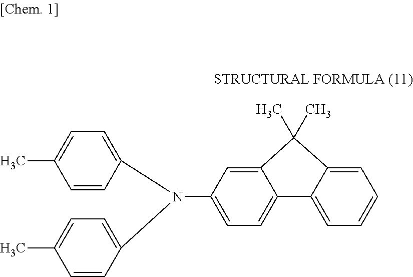 [SMILES: Cc1ccc(N(c2ccc(C)cc2)c2ccc3c(c2)C(C)(C)c2ccccc2-3)cc1]

Subsequently, 30 parts by mass of a hole-transporting compound having a polymerizable functional group and represented by structural formula (12) below was dissolved in 35 parts by mass of 1-propanol and 35 parts by mass of 1,1,2,2,3,3,4-heptafluorocyclopentane (trade name: ZEORORA H, produced by ZEON Corporation). The resulting solution was then pressure-filtered with a 0.5-μm PTFE membrane filter. Thus, a coating solution for a second charge transport layer serving as a curable surface layer was prepared. This coating solution was applied onto the first charge transport layer by a dip-coating method to form a coating film for a second charge transport layer serving as a curable surface layer. The coating film was then irradiated with an electron beam in nitrogen under the conditions of an accelerating voltage of 150 kV and a dose of 15 kGy. Thus, an aluminum cylinder (electrophotographic photosensitive member) having a cured coating film was obtained. Subsequently, heat treatment was performed for 90 seconds under the condition in which the temperature of the electrophotographic photosensitive member became 120° C. The oxygen concentration at this time was 10 ppm. Furthermore, the electrophotographic photosensitive member was heated in air for 20 minutes in a hot-air dryer adjusted at a temperature of 100° C. to form a curable surface layer having a thickness of 5 μm. The resulting image bearing member 1 had an elastic deformation rate of 55%.

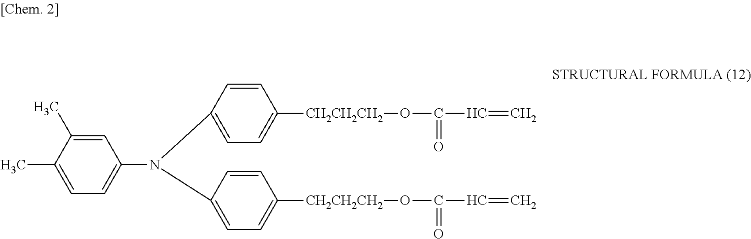

### Electrophotographic Photosensitive Member Production Example 2

An image bearing member was obtained as in Electrophotographic photosensitive member production example 1 except that the electron beam irradiation conditions in Electrophotographic photosensitive member production example 1 were changed to an accelerating voltage of 100 kV and a dose of 10 kGy in nitrogen. The resulting image bearing member 2 had an elastic deformation rate of 45%.

### Electrophotographic Photosensitive Member Production Example 3

An image bearing member was obtained as in Electrophotographic photosensitive member production example 1 except that the electron beam irradiation conditions in Electrophotographic photosensitive member production example 1 were changed to an accelerating voltage of 200 kV and a dose of 20 kGy in nitrogen. The resulting image bearing member 3 had an elastic deformation rate of 65%.

### Examples 1 to 13 and Comparative Examples 1 to 7

A two-component developer was prepared by combining a toner and a magnetic carrier as shown in Table 3. The two-component developer was prepared by adding 10.0 parts by mass of the toner relative to 90.0 parts by mass of the magnetic carrier, and mixing the toner and the magnetic carrier using a V-type mixer.

The developer prepared as described above was packed in a developing device and a refill container described below, and the temperature and humidity were controlled in a room temperature and low humidity environment (temperature: 23° C., humidity: 4% RH) or a high temperature and high humidity environment (temperature: 32.5° C., humidity: 80% RH).

A digital full-color copier Image Press C1 (produced by CANON KABUSHIKI KAISHA) was modified as described below and used as an evaluation machine.

An image bearing member attached to a developing device of the above machine was taken out and was replaced with any one of the image bearing members 1 to 3 prepared above. An alternating current voltage with a frequency of 1.5 kHz and a peak-to-peak voltage (Vpp 1.0 kV) and a direct current voltage V_{DC} were applied to a development sleeve. Furthermore, a cleaning device was modified, and the average contact surface pressure of a contact nip portion between the image bearing member and a cleaning blade was changed as shown in Table 3. Furthermore, the fixing temperature was made to be able to be set freely. The cleaning blade originally attached to the machine was used as it is.

The evaluation was performed as described below using the above developer and evaluation machine. A laser beam printer sheet CS-814 (A4, 81.4 g/m²) was used as a transfer material. The evaluation results are shown in Table 4.

### Evaluation in Room Temperature and Low Humidity Environment (Temperature: 23° C., Humidity: 4% RH) Image Stability

The developing device and the refill container were set in the machine. The developing bias was adjusted so that the amount of development of the toner on the photosensitive member became 0.42 g/cm², and a solid image was output for an initial evaluation.

Next, 15,000 sheets (15 k) of an image with a coverage of 40% was output while a constant amount of toner was supplied so that the toner density was kept constant. After the completion of the 15 k output, a solid image was further output and the density of the solid image was measured. Subsequently, 15,000 sheets (15 k) of an image with a coverage of 1% was further output while a constant amount of toner was supplied so that the toner density was kept constant. Thus, a total of 30,000 sheets (30 k) were output. After the completion of the 30 k output, a solid image was output again and the density of the solid image was measured.

In each of the solid images, the densities at arbitrary 5 points were measured with a densitometer X-Rite 500, and the average value of the densities was defined as the image density. The rates of change in image density D1-D15 and D1-D30 were determined, wherein D1 represents the initial image density, D15 represents the image density after the 15 k output, and D30 represents the image density after the 30 k output.

### Evaluation Criteria of D1-D15

A: The rate of change in image density D1-D15 is less than 0.05.
B: The rate of change in image density D1-D15 is 0.05 or more and less than 0.10.
C: The rate of change in image density D1-D15 is 0.10 or more and less than 0.15.
D: The rate of change in image density D1-D15 is 0.15 or more.

### Evaluation Criteria of D1-D30

A: The rate of change in image density D1-D30 is less than 0.10.
B: The rate of change in image density D1-D30 is 0.10 or more and less than 0.15.
C: The rate of change in image density D1-D30 is 0.15 or more and less than 0.20.
D: The rate of change in image density D1-D30 is 0.20 or more and less than 0.25.
E: The rate of change in image density D1-D30 is 0.25 or more.

### Evaluation in High Temperature and High Humidity Environment (Temperature: 32.5° C., Humidity: 80% RH)

The developing bias was set so that the amount of toner applied onto the photosensitive member became 0.42 g/cm² in an environment of a temperature of 32.5° C. and a humidity of 80% RH. As for an initial evaluation, the evaluation of fogging in a non-image area, the evaluation of cleanability, and the evaluation of transfer residue were conducted as described below.

Next, 15,000 sheets (15 k) of an image with a coverage of 40% was output while a constant amount of toner was supplied so that the toner density was kept constant. After the completion of the 15 k output, the evaluation of fogging in a non-image area and the evaluation of transfer residue were conducted.

Subsequently, 15,000 sheets (15 k) of an image with a coverage of 1% was output while a constant amount of toner was supplied so that the toner density was kept constant. Thus, a total of 30,000 sheets (30 k) were output. After the completion of the 30 k output, the evaluation of fogging in a non-image area and the evaluation of transfer residue were conducted.

### Evaluation of Fogging in Non-Image Area

Blank images were output at an initial stage, after the 15 k output, and the 30 k output. The fog density of a central portion of an output sheet (i.e., transfer material) at a position 50 mm from an end of the transfer material was measured. The density of the transfer material before the output was subtracted from the fog density measured above to determine the difference in density. The difference in fog density at the initial stage, the difference in fog density after the 15 k output, and the difference in fog density after the 30 k output were evaluated on the basis of the evaluation criteria described below. The fog density was measured with a densitometer TC-6DS (produced by Tokyo Denshoku Co., Ltd.).

### Evaluation Criteria at Initial Stage

A: The difference in fog density is less than 0.5.
B: The difference in fog density is 0.5 or more and less than 1.0.
C: The difference in fog density is 1.0 or more and less than 2.0.
D: The difference in fog density is 2.0 or more.
Evaluation Criteria after 15 k Output
A: The difference in fog density is less than 1.0.
B: The difference in fog density is 1.0 or more and less than 1.5.
C: The difference in fog density is 1.5 or more and less than 2.5.
D: The difference in fog density is 2.5 or more.
Evaluation Criteria after 30 k Output
A: The difference in fog density is less than 1.0.
B: The difference in fog density is 1.0 or more and less than 1.5.
C: The difference in fog density is 1.5 or more and less than 2.5.
D: The difference in fog density is 2.5 or more.

### Transfer Efficiency (Density of Transfer Residue)

Solid images were output at an initial stage, after the 15 k output, and after the 30 k output. At that time, the operation was stopped during developing, and a transfer residual toner on a photosensitive drum in the image formation was peeled off with a transparent polyester adhesive tape. The difference in density was calculated for each sample by subtracting the density of the sheet having only an adhesive tape stuck thereon from the density of the sheet having the peeled adhesive tape stuck thereon. The evaluation was conducted on the basis of the evaluation criteria described below. The density of transfer residue was measured with an X-Rite color reflection densitometer (500 Series).

### Evaluation Criteria at Initial Stage

A: The difference in density is less than 0.10.
B: The difference in density is 0.10 or more and less than 0.15.
C: The difference in density is 0.15 or more and less than 0.25.
D: The difference in density is 0.25 or more.
Evaluation Criteria after 15 k Output
A: The difference in density is less than 0.15.
B: The difference in density is 0.15 or more and less than 0.20.
C: The difference in density is 0.20 or more and less than 0.25.
D: The difference in density is 0.25 or more.
Evaluation Criteria after 30 k Output
A: The difference in density is less than 0.15.
B: The difference in density is 0.15 or more and less than 0.20.
C: The difference in density is 0.20 or more and less than 0.30.
D: The difference in density is 0.30 or more.

### Evaluation of Cleanability

A half-tone image was printed after the 30 k output, and evaluation was conducted by visual observation.

### Evaluation Criteria

A: No stain is formed.
B: Minute stains are formed, but there is no practical problem.
C: Spot-like and linear stains are formed in places.
D: Spot-like and linear stains are significantly formed.

### Examples 14 and 15

The image stability, fogging in a non-image area, and the density of transfer residue were evaluated as in Example 2 except that the magnetic carrier used was changed as shown in Table 3. The evaluation results are shown in Table 5.

By changing the true specific gravity of the magnetic carrier, toner-spent to the magnetic carrier was suppressed and fogging in the non-image area due to a decrease in the amount of charge of the toner was improved. It is believed that the toner of the present invention had good stress resistance and thus degradation of fogging in a non-image area was suppressed even in the case where the true specific gravity of the magnetic carrier was changed.

### Examples 16 to 23

The cleanability before and after a large number of sheets were output was evaluated as in Example 2 except that the image bearing member and the average contact surface pressure of a contact nip portion between the image bearing member and the cleaning blade were changed as shown in Table 3. The evaluation results are shown in Table 6.

Although the cleanability at the initial stage is improved by increasing the average contact surface pressure of a contact nip portion between the image bearing member and the cleaning blade, after a large number of sheets were output, the cleanability tended to be degraded in the image bearing member having a large elastic deformation rate because of vibration of the cleaning blade. However, by using the toner of the present invention, the degradation of the cleanability due to vibration of the cleaning blade was suppressed after a large number of sheets were output. Consequently, it is believed that extension of the life can be realized by employing this image forming method.

TABLE 3

| | | | | Elastic | Contact surface |
|---|---|---|---|---|---|
| | | Magnetic | Image bearing | deformation | pressure of blade |
| Example | Toner | carrier | member | rate (%) | (gf/cm²) |
| Example 1 | Toner 1 | Magnetic | Image bearing | 55 | 20 |
| | | carrier 2 | member 1 | | |
| Example 2 | Toner 2 | Magnetic | Image bearing | 55 | 20 |
| | | carrier 2 | member 1 | | |
| Example 3 | Toner 3 | Magnetic | Image bearing | 55 | 20 |
| | | carrier 2 | member 1 | | |
| Example 4 | Toner 4 | Magnetic | Image bearing | 55 | 20 |
| | | carrier 2 | member 1 | | |
| Example 5 | Toner 5 | Magnetic | Image bearing | 55 | 20 |
| | | carrier 2 | member 1 | | |
| Example 6 | Toner 6 | Magnetic | Image bearing | 55 | 20 |
| | | carrier 2 | member 1 | | |
| Example 7 | Toner 7 | Magnetic | Image bearing | 55 | 20 |
| | | carrier 2 | member 1 | | |
| Example 8 | Toner 8 | Magnetic | Image bearing | 55 | 20 |
| | | carrier 2 | member 1 | | |
| Example 9 | Toner 9 | Magnetic | Image bearing | 55 | 20 |
| | | carrier 2 | member 1 | | |
| Example 10 | Toner 10 | Magnetic | Image bearing | 55 | 20 |
| | | carrier 2 | member 1 | | |
| Example 11 | Toner 11 | Magnetic | Image bearing | 55 | 20 |
| | | carrier 2 | member 1 | | |
| Example 12 | Toner 12 | Magnetic | Image bearing | 55 | 20 |
| | | carrier 2 | member 1 | | |
| Example 13 | Toner 13 | Magnetic | Image bearing | 55 | 20 |
| | | carrier 2 | member 1 | | |
| Comparative | Toner 14 | Magnetic | Image bearing | 55 | 20 |
| Example 1 | | carrier 2 | member 1 | | |
| Comparative | Toner 15 | Magnetic | Image bearing | 55 | 20 |
| Example 2 | | carrier 2 | member 1 | | |
| Comparative | Toner 16 | Magnetic | Image bearing | 55 | 20 |
| Example 3 | | carrier 2 | member 1 | | |
| Comparative | Toner 17 | Magnetic | Image bearing | 55 | 20 |
| Example 4 | | carrier 2 | member 1 | | |
| Comparative | Toner 18 | Magnetic | Image bearing | 55 | 20 |
| Example 5 | | carrier 2 | member 1 | | |
| Comparative | Toner 19 | Magnetic | Image bearing | 55 | 20 |
| Example 6 | | carrier 2 | member 1 | | |
| Comparative | Toner 20 | Magnetic | Image bearing | 55 | 20 |
| Example 7 | | carrier 2 | member 1 | | |
| Example 14 | Toner 2 | Magnetic | Image bearing | 55 | 20 |
| | | carrier 3 | member 1 | | |
| Example 15 | Toner 2 | Magnetic | Image bearing | 55 | 20 |
| | | carrier 1 | member 1 | | |
| Example 16 | Toner 2 | Magnetic | Image bearing | 55 | 10 |
| | | carrier 2 | member 1 | | |
| Example 17 | Toner 2 | Magnetic | Image bearing | 55 | 30 |
| | | carrier 2 | member 1 | | |
| Example 18 | Toner 2 | Magnetic | Image bearing | 45 | 10 |
| | | carrier 2 | member 2 | | |
| Example 19 | Toner 2 | Magnetic | Image bearing | 45 | 20 |
| | | carrier 2 | member 2 | | |
| Example 20 | Toner 2 | Magnetic | Image bearing | 45 | 30 |
| | | carrier 2 | member 2 | | |
| Example 21 | Toner 2 | Magnetic | Image bearing | 65 | 10 |
| | | carrier 2 | member 3 | | |
| Example 22 | Toner 2 | Magnetic | Image bearing | 65 | 20 |
| | | carrier 2 | member 3 | | |
| Example 23 | Toner 2 | Magnetic | Image bearing | 65 | 30 |
| | | carrier 2 | member 3 | | |

TABLE 4

| | | | Fogging | | | | | | |
|---|---|---|---|---|---|---|---|---|---|
| | Image stability | | | After | After | Transfer residue | | | Cleanability |
| Example | D1-D15 | D1-D30 | Initial | 15k | 30k | Initial | After 15k | After 30k | After 30k |
| Example 1 | A | A | A | A | A | A (0.07) | A (0.11) | B (0.18) | A |
| | 0.02 | 0.04 | 0.2 | 0.5 | 0.8 | | | | |
| Example 2 | A | B | A | A | B | A (0.07) | A (0.13) | C (0.21) | A |
| | 0.04 | 0.12 | 0.3 | 0.9 | 1.4 | | | | |
| Example 3 | A | A | A | A | A | A (0.06) | A (0.09) | B (0.15) | A |
| | 0.02 | 0.05 | 0.3 | 0.5 | 0.8 | | | | |
| Example 4 | A | B | A | A | B | A (0.08) | A (0.12) | B (0.18) | C |
| | 0.04 | 0.14 | 0.3 | 0.9 | 1.4 | | | | |
| Example 5 | A | B | A | A | B | A (0.06) | A (0.09) | B (0.15) | B |
| | 0.03 | 0.14 | 0.4 | 0.8 | 1.3 | | | | |
| Example 6 | B | C | A | B | C | A (0.08) | B (0.15) | C (0.24) | B |
| | 0.08 | 0.15 | 0.3 | 1.1 | 1.6 | | | | |
| Example 7 | A | B | A | A | B | A (0.07) | A (0.12) | B (0.19) | A |
| | 0.04 | 0.12 | 0.3 | 0.8 | 1.3 | | | | |
| Example 8 | A | B | A | A | B | A (0.05) | A (0.09) | B (0.15) | B |
| | 0.04 | 0.14 | 0.4 | 0.8 | 1.2 | | | | |
| Example 9 | A | B | A | A | B | A (0.04) | A (0.08) | A (0.12) | C |
| | 0.03 | 0.13 | 0.3 | 0.7 | 1.1 | | | | |
| Example 10 | A | C | A | A | C | A (0.04) | A (0.07) | A (0.11) | C |
| | 0.04 | 0.15 | 0.3 | 0.9 | 1.5 | | | | |
| Example 11 | B | C | A | B | C | A (0.09) | A (0.13) | C (0.22) | C |
| | 0.09 | 0.19 | 0.3 | 1.1 | 1.6 | | | | |
| Example 12 | B | D | A | B | C | A (0.07) | A (0.09) | B (0.16) | C |
| | 0.09 | 0.2 | 0.3 | 1.2 | 1.8 | | | | |
| Example 13 | B | D | A | B | C | A (0.05) | A (0.07) | A (0.12) | C |
| | 0.05 | 0.22 | 0.3 | 1.1 | 1.9 | | | | |
| Comparative | C | E | A | C | E | A (0.07) | A (0.09) | B (0.16) | D |
| Example 1 | 0.14 | 0.3 | 0.3 | 1.8 | 2.5 | | | | |
| Comparative | C | E | A | C | E | B (0.13) | B (0.17) | D (0.30) | C |
| Example 2 | 0.14 | 0.28 | 0.3 | 1.9 | 2.5 | | | | |
| Comparative | B | E | A | B | C | A (0.07) | A (0.09) | B (0.17) | D |
| Example 3 | 0.05 | 0.25 | 0.3 | 1.2 | 1.9 | | | | |
| Comparative | A | D | A | A | B | A (0.03) | A (0.05) | A (0.07) | D |
| Example 4 | 0.04 | 0.22 | 0.4 | 0.8 | 1.4 | | | | |
| Comparative | C | E | A | B | C | A (0.04) | A (0.11) | C (0.22) | D |
| Example 5 | 0.11 | 0.25 | 0.2 | 1.2 | 1.8 | | | | |
| Comparative | C | C | A | B | C | B (0.13) | C (0.24) | D (0.32) | A |
| Example 6 | 0.11 | 0.15 | 0.2 | 1.4 | 1.6 | | | | |
| Comparative | D | E | A | C | E | C (0.15) | D (0.25) | D (0.33) | A |
| Example 7 | 0.15 | 0.26 | 0.3 | 1.9 | 2.7 | | | | |

TABLE 5

| | | | Fogging | | | | | |
|---|---|---|---|---|---|---|---|---|
| | Image stability | | | After | After | Transfer residue | | |
| Example | D1-D15 | D1-D30 | Initial | 15k | 30k | Initial | After 15k | After 30k |
| Example 2 | A | B | A | A | B | A (0.07) | A (0.13) | C (0.21) |
| | 0.04 | 0.12 | 0.3 | 0.9 | 1.4 | | | |
| Example 14 | A | C | A | C | C | A (0.07) | B (0.15) | C (0.23) |
| | 0.05 | 0.15 | 0.3 | 1.5 | 1.9 | | | |
| Example 15 | A | B | A | A | B | A (0.07) | A (0.09) | B (0.18) |
| | 0.03 | 0.10 | 0.3 | 0.9 | 1.3 | | | |

TABLE 6

Cleanability

| Example | Initial | After 30k |
|---|---|---|
| Example 2 | A | A |
| Example 16 | A | A |
| Example 17 | A | B |
| Example 18 | A | A |
| Example 19 | A | A |
| Example 20 | A | A |
| Example 21 | A | A |
| Example 22 | A | B |
| Example 23 | A | C |

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2011-130263, filed Jun. 10, 2011, which is hereby incorporated by reference herein in its entirety.

### REFERENCE SIGNS LIST

1 heat treatment apparatus
2 hot-air supply unit
2A air flow-adjusting portion
3 first cold-air supply unit
3A air flow-adjusting portion
4 second cold-air supply unit
5 third cold-air supply unit
6 first tubular member
7 second tubular member
8 raw material supply unit
9 first nozzle
10 second nozzle
10A turn-up portion
10B rib
13 collecting unit
14 pole
15 compressed gas supply unit (ejector)
16 fixed-quantity raw material feeder
17 heater
19 raw material collection unit (bag)
20 suction discharge unit (blower)
30 cold-air supply device

1. A toner comprising:
toner particles each of which contains a binder resin and a wax; and
inorganic fine particles,
wherein
(i) the toner has a weight-average particle diameter (D4) of 3.0 μm or more and 8.0 μm or less,
(ii) in a measurement using a flow particle image measuring apparatus with an image processing resolution of 512×512 pixels, the toner satisfies the following conditions (a) and (b):
(a) regarding particles having an equivalent circle diameter of 1.98 μm or more and less than 200.00 μm, the average circularity of the toner is 0.960 or more and 0.985 or less, and the proportion of particles having a circularity of 0.990 or more and 1.000 or less is 25.0% or less on a basis of the number of particles, and
(b) the ratio of particles having an equivalent circle diameter of 0.50 μm or more and less than 1.98 μm to particles having an equivalent circle diameter of 0.50 μm or more and less than 200.00 μm is 10.0% or less on a basis of the number of particles, and
(iii) the relationship of formula (1) is satisfied:
1.20≦P1/P2≦2.00 Formula (1)
where P1=Pa/Pb and P2=Pc/Pd,
Pa and Pb respectively represent a maximum absorption peak intensity in the range of 2,843 cm⁻¹ or more and 2,853 cm⁻¹ or less and a maximum absorption peak intensity in the range of 1,713 cm⁻¹ or more and 1,723 cm⁻¹ or less in a Fourier transform infrared (FT-IR) spectrum of the toner measured by an attenuated total reflection (ATR) method using germanium (Ge) as an ATR crystal at an angle of incidence of infrared light of 45°, and
Pc and Pd respectively represent a maximum absorption peak intensity in the range of 2,843 cm⁻¹ or more and 2,853 cm⁻¹ or less and a maximum absorption peak intensity in the range of 1,713 cm⁻¹ or more and 1,723 cm⁻¹ or less in an FT-IR spectrum of the toner measured by an ATR method using KRS5 as an ATR crystal at an angle of incidence of infrared light of 45°.

2. The toner according to claim 1, wherein the toner particles are subjected to a surface treatment with hot air.

3. The toner according to claim 1, wherein the toner particles are produced by subjecting a raw material toner containing inorganic fine particles to a surface treatment with hot air.

4. A two-component developer comprising:
the toner according to claim 1; and
a magnetic carrier.

5. An image forming method comprising:
a charging step of charging an image bearing member;
a latent image forming step of forming an electrostatic latent image on the image bearing member charged in the charging step;
a developing step of developing the electrostatic latent image formed on the image bearing member with a two-component developer containing a toner to form a toner image;
a transfer step of transferring the toner image on the image bearing member to a transfer material either directly or through an intermediate transfer member;
a cleaning step of cleaning a transfer residual toner on the surface of the image bearing member; and
a fixing step of fixing the toner image to the transfer material by applying heat and/or pressure,
wherein the two-component developer is the two-component developer according to claim 4.

6. The image forming method according to claim 5,
wherein the cleaning step is a blade cleaning step of conducting cleaning by bringing a blade into contact with the surface of the image bearing member, and
an outermost surface layer of the image bearing member has an elastic deformation rate of 40% or more and 70% or less.
